(19) United States
(12) Patent Application Publication
(10) Pub. No.: US 2026/0143248 A1
(43) Pub. Date: May 21, 2026

(54) IMAGE SENSOR, DATA PROCESSING DEVICE, AND IMAGE SENSOR SYSTEM

(71) Applicant: SONY SEMICONDUCTOR SOLUTIONS CORPORATION, KANAGAWA (JP)

(72) Inventor: TAKAHIRO MIYAZAKI, KANAGAWA (JP)

(21) Appl. No.: 18/697,013

(22) PCT Filed: Oct. 5, 2022
(86) PCT No.: PCT/JP2022/037206

§ 371 Date: Mar. 29, 2024

(30) Foreign Application Priority Data
Oct. 8, 2021 (JP) 2021-166419

(51) Int. Cl. H04N 25/47; H04N 23/745

(52) U.S. Cl. CPC H04N 25/47; H04N 23/745

(57) ABSTRACT

The present disclosure relates to an image sensor, a data processing device, and an image sensor system capable of further improving versatility. The image sensor includes: a luminance detecting unit that detects luminance of light received by a photodiode and outputs a luminance signal representing a luminance value of the luminance; and an event detecting unit that acquires a difference between the luminance value represented by the luminance signal and a predetermined reference value and, in a case in which the difference exceeds an event detection threshold of a positive side or an event detection threshold of a negative side, detects an occurrence of the event and outputs the event data representing details of the event; an additional information generating unit that generates pixel information added to data of each pixel as additional information that is additionally disposed in event data on the basis of the event data; and a data transmitting unit that transmits pixel information in a frame structure in which the pixel information is embedded in the event data. The present technology, for example, can be applied to an event based vision sensor (EVS).

### TECHNICAL FIELD

The present disclosure relates to an image sensor, a data processing device, and an image sensor system and, more particularly, to an image sensor, a data processing device, and an image sensor system capable of further improving versatility.

### BACKGROUND ART

In recent years, development of image sensors detecting a luminance change of each pixel in real time as an event (hereinafter, referred to as event-based vision sensors (EVS)) has been progressed.

For example, in PTL 1, a sensor architecture capable of performing sampling in a frame-based system, an event-based system, and a hybrid system of a frame-based system and an event-based system is disclosed.

### CITATION LIST

### Patent Literature

### PTL 1

Japanese Translation of PCT Application No. 2017-535999

SUMMARY

### Technical Problem

However, conventionally, due to its event-driven nature, an output format of data output from an EVS is not determined, and thus it is necessary to newly design an evaluation system receiving the data.

The present disclosure is formed in consideration of such a situation and enables further improvement of versatility.

### Solution to Problem

According to one aspect of the present disclosure, there is provided an image sensor including: an event detecting unit that detects an occurrence of an event that is a luminance change of light received by a photodiode; and a data transmitting unit that sets event data representing details of the event as a part of payload data and transmits pixel information added to data of each pixel including the photodiode in a frame structure in which the pixel information is embedded in the event data.

According to one aspect of the present disclosure, there is provided a data processing device including: a data receiving unit receiving pixel information added to data of each pixel including a photodiode in a frame structure in which the pixel information is embedded in event data with the event data representing details of an event that is a luminance change of light received by the photodiode set as a part of payload data; and an event-related data processing unit performing data processing relating to the event by referring to the pixel information.

According to one aspect of the present disclosure, there is provided an image sensor system including: an image sensor including: an event detecting unit detecting an occurrence of an event that is a luminance change of light received by a photodiode; and a data transmitting unit transmitting pixel information added to data of each pixel including the photodiode in a frame structure in which the pixel information is embedded in event data with the event data representing details of the event set as a part of payload data, and a data processing device including: a data receiving unit receiving the event data and the pixel information; and an event-related data processing unit performing data processing relating to the event by referring to the pixel information.

According to one aspect of the present disclosure, an occurrence of an event that is a luminance change of light received by a photodiode is detected, and pixel information is transmitted in a frame structure in which the pixel information added to data of each pixel including the photodiode is embedded in event data with the event data representing details of the event set as a part of payload data. Then, the event data and the pixel information are received, and data processing relating to the event is performed by referring to the pixel information.

### BRIEF DESCRIPTION OF DRAWINGS

FIG. 1 is a block diagram illustrating a configuration example of one embodiment of a sensor system to which the present technology is applied.

FIG. 2 is a block diagram illustrating a configuration example of an EVS of a three-chip stacked structure.

FIG. 3 is a diagram illustrating one example of a frame configuration of event data corresponding to one frame.

FIG. 4 is a diagram illustrating an arrangement example of embedded data.

FIG. 5 is a diagram illustrating a first example of a frame configuration in which event data corresponding to three frames is connected in one frame.

FIG. 6 is a diagram illustrating a second example of a frame configuration in which event data corresponding to three frames is connected in one frame.

FIG. 7 is a block diagram illustrating a first configuration example of an additional information generating unit.

FIG. 8 is a diagram describing a time stamp, a frame number, and a data amount.

FIG. 9 is a diagram describing presence/absence of flicker and event data.

FIG. 10 is a diagram illustrating one example of a frame configuration in which frame information is stored.

FIG. 11 is a block diagram illustrating a configuration example of a data processing device.

FIG. 12 is a block diagram illustrating a configuration example of an additional information generating unit corresponding to an arbiter type.

FIG. 13 is a diagram describing a process performed by a frame generating unit.

FIG. 14 is a block diagram illustrating a second configuration example of an additional information generating unit.

FIG. 15 is a diagram illustrating one example of a frame configuration in which line information is stored.

FIG. 16 is a diagram illustrating another example of a frame configuration in which line information is stored.

FIG. 17 is a block diagram illustrating a configuration example of an additional information generating unit corresponding to an arbiter type.

FIG. 18 is a block diagram illustrating a third configuration example of an additional information generating unit.

FIG. 19 is a diagram illustrating one example of a frame configuration in which pixel information is stored.

FIG. 20 is a diagram describing a transmission method of pixel information.

FIG. 21 is a block diagram illustrating a configuration example of an additional information generating unit corresponding to an arbiter type.

FIG. 22 is a block diagram illustrating a configuration example of a sensor system in which a physical layer can be switched between a serializer and a de-serializer.

FIG. 23 is a block diagram illustrating a configuration example of a sensor system in which a physical layer can be switched between an EVS and a data processing device.

FIG. 24 is a diagram describing a configuration example of an electronic device including an EVS.

FIG. 25 is a block diagram illustrating a schematic configuration example of an EVS.

FIG. 26 is a circuit diagram illustrating a schematic configuration example of an event pixel.

FIG. 27 is a block diagram illustrating a configuration example of an EVS of a scanning type.

FIG. 28 is a block diagram illustrating a configuration example of a sensor system including a plurality of sensors.

FIG. 29 is a diagram illustrating a first example of a result of control of connection of images.

FIG. 30 is a diagram illustrating a second example of a result of control of connection of images.

FIG. 31 is a diagram illustrating a third example of a result of control of connection of images.

FIG. 32 is a diagram illustrating a fourth example of a result of control of connection of images.

FIG. 33 is a diagram illustrating a fifth example of a result of control of connection of images.

FIG. 34 is an explanatory diagram illustrating one example of data transmitted using a first transmission system.

FIG. 35 is an explanatory diagram describing one example of embedded data transmitted using the first transmission system.

FIG. 36 is a diagram illustrating usage examples of an image sensor.

### DESCRIPTION OF EMBODIMENTS

Hereinafter, specific embodiments to which the present disclosure is applied will be described in detail with reference to the drawings.

### Configuration Example of Sensor System

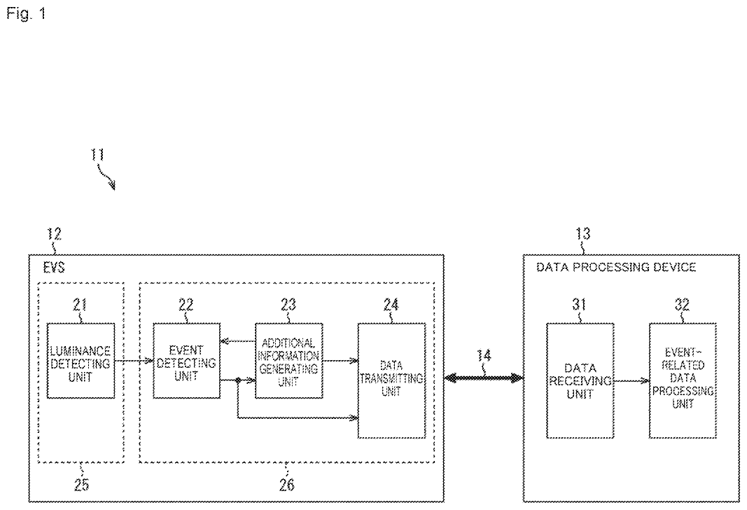

FIG. 1 is a block diagram illustrating a configuration example of one embodiment of a sensor system 11 to which the present technology is applied.

In FIG. 1, in the sensor system 11, an EVS 12 and a data processing device 13 are connected to each other through a data bus 14.

The EVS 12 is an image sensor that detects a luminance change of each pixel as an event in real time and transmits event data representing details of the event to the data processing device 13 through the data bus 14. The EVS 12 is configured to include a luminance detecting unit 21, an event detecting unit 22, an additional information generating unit 23, and a data transmitting unit 24.

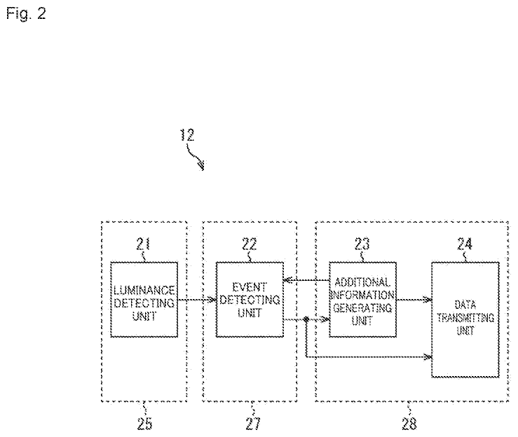

For example, the EVS 12 can be configured to have a stacked structure in which two chips including a pixel chip 25 in which the luminance detecting unit 21 is disposed and a signal processing chip 26 in which the event detecting unit 22, the additional information generating unit 23, and the data transmitting unit 24 are disposed are stacked. Here, the event detecting unit 22 is an analog circuit that serves as an analog front end (AFE). Thus, the EVS 12, as illustrated in FIG. 2, may have a stacked structure in which three chips including a pixel chip 25 in which the luminance detecting unit 21 is disposed, an AFE chip 27 in which the event detecting unit 22 is disposed, and a logic chip 28 in which the additional information generating unit 23 and the data transmitting unit 24 are disposed are stacked.

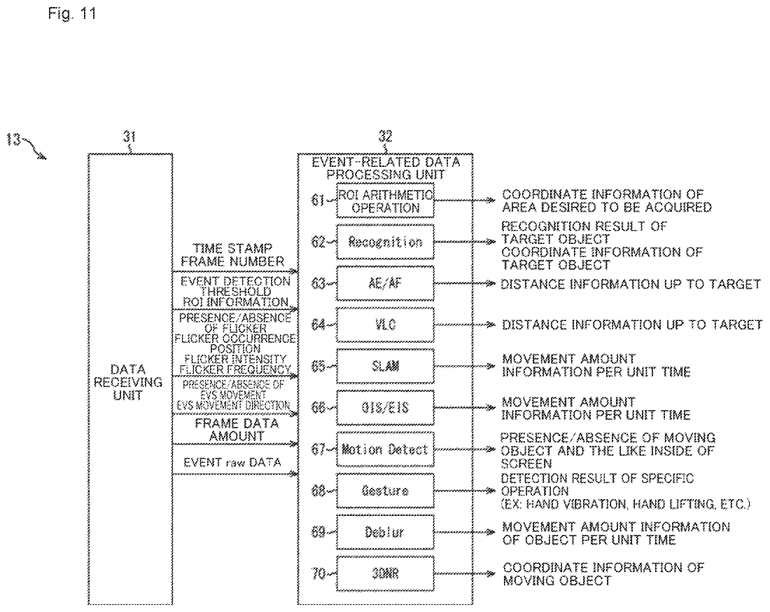

The data processing device 13, for example, is configured using an application processor, a field programmable gate array (FPGA), and the like. The data processing device 13 performs various kinds of data processing on event data transmitted from the EVS 12 and acquires various kinds of information relating to an event. The data processing device 13 is configured to have a data receiving unit 31 and an event-related data processing unit 32, and details thereof will be described with reference to FIG. 11 to be described below.

The data bus 14, for example, transmits/receives data between the EVS 12 and the data processing device 13 in compliance with Camera Serial Interface-2 (CSI-2) that is a standard of an interface according to a Mobile Industry Processor Interface (MIPI) Alliance.

The luminance detecting unit 21 is configured to have a photodiode disposed for each pixel, detects luminance of light received by the photodiode, and supplies a luminance signal representing a luminance value thereof to the event detecting unit 22.

The event detecting unit 22 acquires a difference between a luminance value represented by a luminance signal supplied from the luminance detecting unit 21 and a predetermined reference value and detects an occurrence of an event in a case in which the difference exceeds an event detection threshold of the positive side or an event detection threshold of the negative side. When an occurrence of an event is detected, the event detecting unit 22 outputs event data representing details of the event (for example, data representing a side out of the positive side and the negative side to which the luminance has changed from a reference value). In addition, event data output from the event detecting unit 22 will be appropriately referred to as event raw data.

The additional information generating unit 23 generates various kinds of additional information that is additionally provided in event data on the basis of the event data output from the event detecting unit 22 and supplies the generated additional information to the data transmitting unit 24. For example, the additional information generating unit 23 can generate frame information, line information, and pixel information as described below as additional information in addition to the embedded data defined in CSI-2.

The data transmitting unit 24 transmits event data output from the event detecting unit 22 and additional information supplied from the additional information generating unit 23 to the data processing device 13 in a frame configuration according to the standard of the data bus 14.

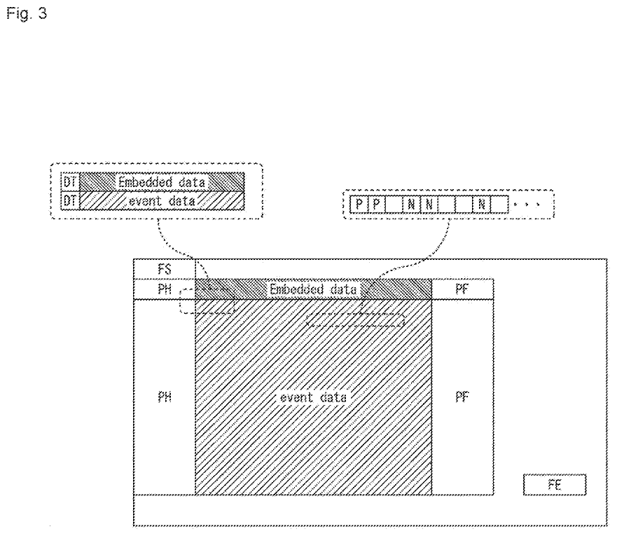

FIG. 3 is a diagram illustrating one example of a frame configuration of event data corresponding to one frame that is transmitted from the EVS 12 to the data processing device 13.

As illustrated in FIG. 3, event data corresponding to one frame is stored in a plurality of long packets arranged in a line shape between a frame start FS that is a short packet representing a start of a frame and a frame end FE that is a short packet representing an end of the frame. In addition, in the example illustrated in FIG. 3, a long packet in which embedded data is stored is disposed at the beginning of a long packet in which event data is stored.

In the long packet, a packet header PH and a packet footer PF are disposed. In the packet header PH, a data type DT representing a type of data stored in the long packet is disposed, and which one of embedded data and event data is stored can be judged in accordance with the data type DT. In addition, the data type DT may be disposed at the beginning of an area in which data is stored in a long packet instead of being arranged in the packet header PH.

As event data, for example, polarity information of an event that is data representing positivity P in a pixel of which a luminance value has changed from a reference value to the positive side and represents negativity N in a pixel of which a luminance value has changed from the reference value to the negative side can be used. In addition, as the event data, data other than the polarity information of an event may be used.

Furthermore, the arrangement position of the embedded data is not limited to the beginning of the event data as illustrated in FIG. 3. In addition, a frame configuration in which a plurality of pieces of embedded data are arranged may be employed.

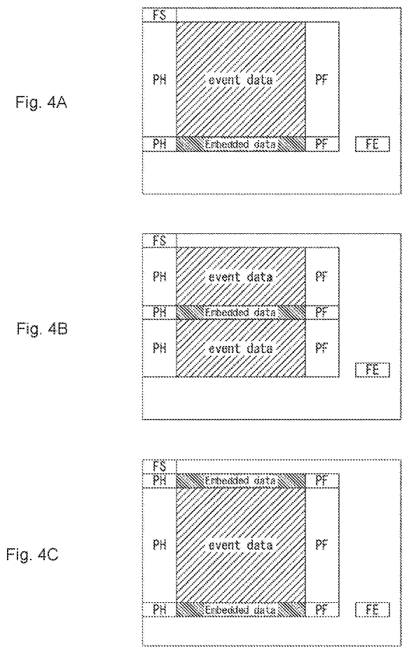

For example, a frame configuration in which an insertion position of the embedded data is at the end of the event data, as illustrated in A of FIG. 4, may be employed, or as illustrated in B of FIG. 4, a frame configuration in which the insertion position is in the middle of the event data may be employed.

In addition, as illustrated in C of FIG. 4, a frame configuration in which embedded data is arranged at both the beginning and the end of event data can be employed. For example, in a case in which information determined at a time point at which an event is acquired like a time stamp, a frame number, and the like is used as embedded data, it is appropriate to arrange the embedded data at the beginning of the event data. On the other hand, in a case in which information requiring a predetermined arithmetic operation after acquisition of an event, for example, information relating to flicker, an optical flow, a threshold, and the like is used as embedded data, it is appropriate to arrange the embedded data at the end of the event data.

In addition, instead of transmitting single event data corresponding to one piece of image data as one frame, a plurality of pieces of event data corresponding to a plurality of pieces of image data may be connected and transmitted as one frame.

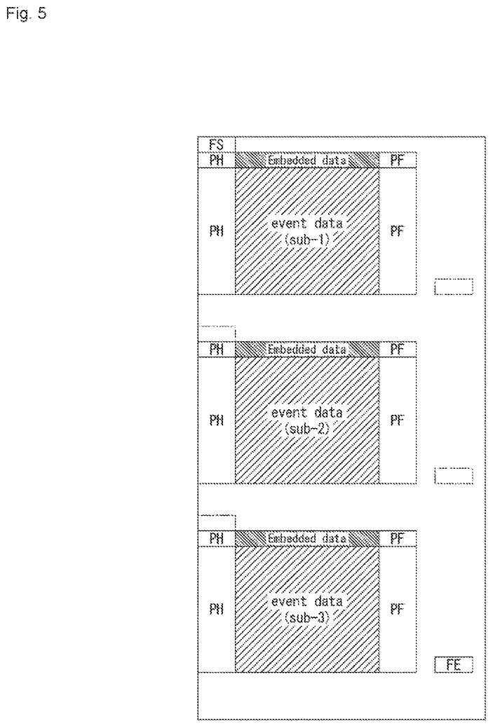

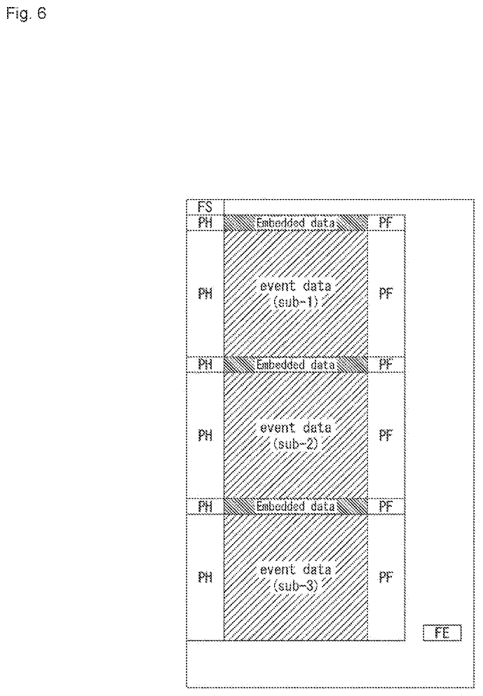

A frame structure in which event data of three frames corresponding to three images is connected as subframes and is transmitted as one frame will be described with reference to FIGS. 5 and 6.

A frame structure illustrated in FIG. 5 is configured as one frame by causing a frame end FE of a subframe that becomes first event data, a frame start FS and a frame end FE of a subframe that becomes second event data, and a frame start FS of a subframe that becomes third event data not to be recognized. In other words, by causing only the frame start FS of the subframe that becomes the first event data and the frame end FE of the subframe that becomes the third event data to be recognized, even if the event data transmitted therebetween does not actually have a connected structure, the event data is regarded as one frame.

In a frame structure illustrated in FIG. 6, by configuring a structure in which a subframe that becomes first event data, a subframe that becomes second event data, and a subframe that becomes third event data are actually connected, one frame is configured. In addition, a space may be disposed between subframes thereof.

For example, by configuring the data receiving unit 31 to include an internal counter and counting a subframe number using the data receiving unit 31, event data can be received by recognizing a plurality of subframes as one frame.

### First Configuration Example of Additional Information Generating Unit

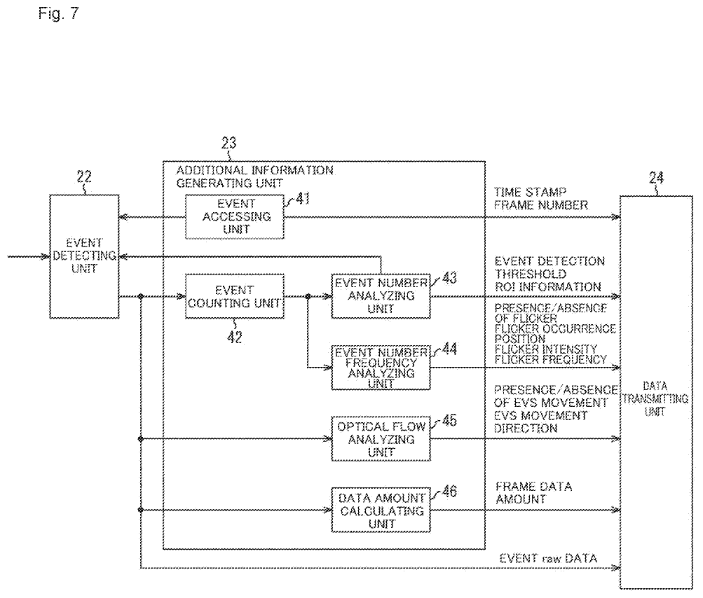

FIG. 7 is a block diagram illustrating a first configuration example of the additional information generating unit 23.

The additional information generating unit 23 illustrated in FIG. 7 generates frame information added to a frame as additional information that is additionally disposed in event data. For example, the frame information is data that may be acquired once in a predetermined period of which a minimum resolution is one frame or more.

For example, as frame information, the additional information generating unit 23 generates information of frame information itself, threshold information, flicker information, movement information, and region of interest (ROI) information. Other than that, information representing various setting values, an event polarity, a type of data (a type including a possibility other than an event), and the like may be used as the frame information.

As the information of frame information itself, a time stamp representing a time when the frame is generated, a frame number representing the order of the frame, a frame data amount representing the data amount of data configuring the frame, and the like are used. As the threshold information, an event detection threshold that is a threshold for detecting an occurrence of an event (the event detection threshold of the positive side and the event detection threshold of the negative side as described above) is used. As the flicker information, information representing presence/absence of flicker, a generation position of flicker, an intensity of flicker, and a frequency of flicker is used. As the movement information, information representing presence/absence of movement and a movement direction of the EVS 12 is used. The ROI information is information representing a target area that is an area that becomes a target in which an event has been detected.

The additional information generating unit 23 is configured to include an event accessing unit 41, an event counting unit 42, an event number analyzing unit 43, an event number frequency analyzing unit 44, an optical flow analyzing unit 45, and a data amount calculating unit 46.

The event accessing unit 41 generates a time stamp and a frame number and supplies them to the data transmitting unit 24. In addition, the event accessing unit 41 instructs a timing at which the event detecting unit 22 scans event data.

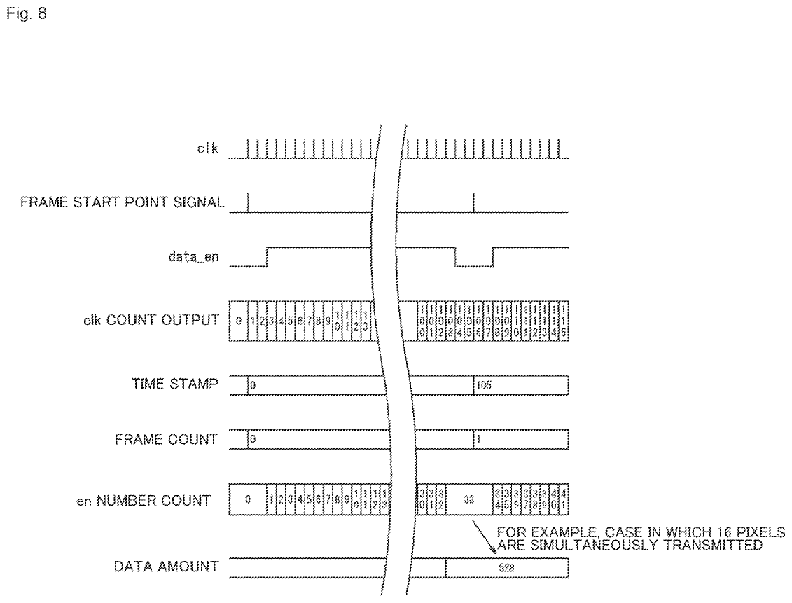

For example, the event accessing unit 41 has a circuit for counting a clock clk as illustrated in FIG. 8 and, when an instruction is received from the outside, can operate in accordance with the internal timer thereafter. For example, the event accessing unit 41 generates a clk count output at a timing at which a frame start point signal instructing the event detecting unit 22 about a start point of a frame becomes on as a time stamp. In addition, the event accessing unit 41 generates a frame count that is counted up at a timing at which a time stamp is generated as a frame number.

The event counting unit 42 counts the number of times of occurrence of an event on the basis of event raw data supplied from the event detecting unit 22 and supplies an event number representing a count value thereof to the event number analyzing unit 43 and the event number frequency analyzing unit 44.

By analyzing the event number supplied from the event counting unit 42, the event number analyzing unit 43 performs setting of an event detection threshold and generation of ROI information and supplies the event detection threshold and the ROI information to the data transmitting unit 24.

For example, in a case in which the event number is too large, the event number analyzing unit 43 determines that the current event detection threshold is lowly set and sets the event detection threshold to be high such that occurrences of events are at an appropriate frequency. On the other hand, in a case in which the event number is too small, the event number analyzing unit 43 determines that the current event detection threshold is highly set and sets the event detection threshold to be low such that occurrences of events are at an appropriate frequency. Then, the event number analyzing unit 43 can adjust the frequency at which an event is detected by feeding back the event threshold to the event detecting unit 22. Although the event detection threshold is, generally, set from the outside of the EVS 12, it may be adaptively set inside of the EVS 12 using the event number analyzing unit 43, and the event detection threshold set by the event number analyzing unit 43 needs to be output to the outside.

The event number frequency analyzing unit 44 acquires flicker information representing presence/absence of flicker, a generation position of flicker, an intensity of flicker, and a frequency of flicker by analyzing the frequency of the event number supplied from the event counting unit 42 and supplies the acquired flicker information to the data transmitting unit 24. For example, the flicker information represents information of a flicker light source present on the screen.

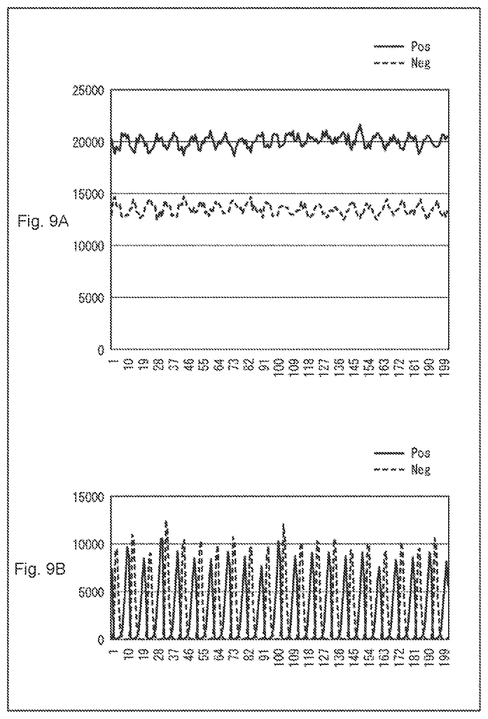

For example, a sampling example of event data in a state in which no flicker is generated is illustrated in A of FIG. 9, and a sampling example of event data in a state in which flicker is generated is illustrated in B of FIG. 9 For example, in a case in which flicker is generated in accordance with blinking of a light source, event data of positivity and negativity appears to deviate in blinking. In this way, the flicker appears as an event number, and thus the flicker information can be acquired by the event counting unit 42 and the event number frequency analyzing unit 44.

The optical flow analyzing unit 45 performs an optical flow analysis in which movement is analyzed from luminance information of the inside of an image on the basis of event raw data supplied from the event detecting unit 22, and movement of an object is acquired using a velocity vector. In this way, the optical flow analyzing unit 45 acquires information representing movement/no-movement and a movement direction of the EVS 12 and supplies the acquired information to the data transmitting unit 24.

The data amount calculating unit 46 calculates a frame data amount that is a data amount per frame on the basis of event raw data supplied from the event detecting unit 22 and supplies the calculated frame data amount to the data transmitting unit 24.

For example, as illustrated in FIG. 8, the data amount calculating unit 46 can calculate a frame data amount on the basis of an en number count value acquired by counting clocks clk of a period in which a data enable signal data_en is on. In addition, in a case in which event data of a plurality of pixels is simultaneously transmitted, the en number count value may be multiplied by the number thereof, and when the en number count value is 33, and event data of 16 pixels is simultaneously transmitted, the frame data amount becomes 528.

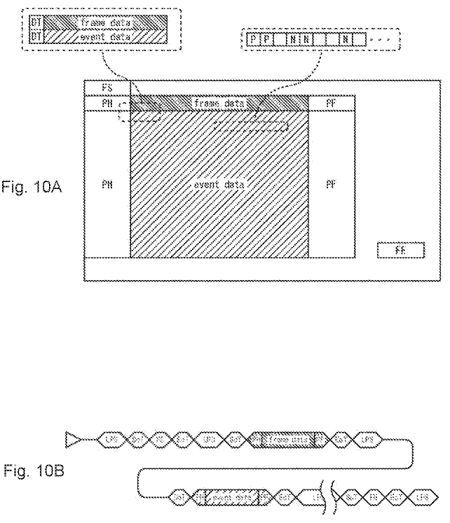

In this way, the additional information generating unit 23 can supply the time stamp, the frame number, the event detection threshold, the ROI information, the flicker information, the information representing movement/no-movement and the movement direction of the EVS 12, and the frame data amount to the data transmitting unit 24. Then, the data transmitting unit 24 stores such information in a frame structure as illustrated in A of FIG. 10 as frame information and can transmit the information together with the event data to the data processing device 13 through the data bus 14. In B of FIG. 10, one example of an output format of frame information and event data output in compliance with the CSI-2 standard is illustrated.

In other words, the data transmitting unit 24 can store frame information in accordance with the arrangement position of the embedded data in the frame structure described with reference to FIG. 3. For example, frame information may be configured to be included in a part of the embedded data. In addition, the insertion position of the frame information, similar to the above-described embedded data illustrated in FIG. 4, may be an end or the middle of the event data, and the frame information may be arranged at both the start and the end of the event data. Furthermore, as illustrated in FIGS. 5 and 6 described above, even when a plurality of pieces of event data are connected and set as one frame, similar to the embedded data in each subframe, the frame information can be stored.

The EVS 12 including the additional information generating unit 23 configured as described above, similar to the embedded data, employs a frame structure in which frame information is stored and can transmit the frame information in an output format according to this frame structure. In other words, the EVS 12 transmits frame information as a part of embedded data in a frame structure in which event data is a part of payload data. In accordance with this, the EVS 12 can further improve versatility.

### Configuration Example of Data Processing Device

FIG. 11 is a block diagram illustrating a configuration example of the data processing device 13.

As illustrated in FIG. 1 described above, the data processing device 13 is configured to have a data receiving unit 31 and an event-related data processing unit 32.

The data receiving unit 31 receives frame information and event raw data transmitted from the data transmitting unit 24 in the frame structure as illustrated in FIG. 10. Then, the data receiving unit 31 supplies event raw data to the event-related data processing unit 32 as it is, extracts various kinds of information included in the frame information, and supplies the extracted information to the event-related data processing unit 32. In other words, the time stamp, the frame number, the event detection threshold, the ROI information, the flicker information, the information representing movement/non-movement and the movement direction of the EVS 12, and the frame data amount are supplied to the event-related data processing unit 32 from the data receiving unit 31.

The event-related data processing unit 32 refers to various types of information included in the frame information and can perform various kinds of data processing relating to an event detected by the event detecting unit 22 on event raw data supplied from the data receiving unit 31.

As illustrated in the drawing, the event-related data processing unit 32 is configured to have an ROI arithmetic operation processing unit 61, a recognition processing unit 62, an AE/AF processing unit 63, a VLC processing unit 64, a SLAM processing unit 65, an OIE/EIS processing unit 66, a motion detection processing unit 67, a gesture processing unit 68, a deblur processing unit 69, and a 3DNR processing unit 70. Each process described here is merely one example, and the event-related data processing unit 32 can perform various processes other than processes described here on the basis of the event raw data.

The ROI arithmetic operation processing unit 61, for example, performs an ROI arithmetic operation process of acquiring coordinate information of an area desired to be acquired and outputs the coordinate information of the area.

For example, the recognition processing unit 62 performs a recognition process of recognizing a target object that has generated an event and outputs a recognition result of the target object and coordinate information.

The auto exposure (AE)/auto focus (AF) processing unit 63 outputs distance information representing a distance to a target that is acquired in an AE/AF process of automatically matching an exposure or a focus to the target that has generated an event.

The VLC processing unit 64 acquires distance information representing a distance to a target by performing a VLC process and outputs the distance information.

The SLAM (Simultaneous Localization and Mapping) processing unit 65 acquires a movement amount information representing a movement amount of the EVS 12 per unit time by performing a SLAM process in which estimation of a self-position and generation of an environmental map are simultaneously performed and outputs the acquired movement amount information.

The OIS/EIS (Optical Image Stabilization/Electronic Image Stabilizer) processing unit 66 outputs movement amount information representing a movement amount of the EVS 12 per unit time that is acquired in an OIE/EIS process in which anti-shake correction of an optical type or anti-shake correction of an electronic type is performed.

The motion detection processing unit 67 performs a motion detection process in which presence/absence of a moving object and the like inside of the screen are detected and outputs information representing presence/absence of the moving object and the like.

The gesture processing unit 68 performs a gesture process in which a specific operation performed by an object is detected and outputs information representing a result of the detection (for example, an operation of waving hand, an operation of raising one's hand, or the like).

The deblur processing unit 69 outputs a movement amount information representing a movement amount of an object per unit time that is acquired in a deblurring process in which blur of an object is removed.

The 3DNR processing unit 70 output coordinate information representing coordinates of a moving object that is acquired in a 3DNR process in which a three-dimensional noise of an object is eliminated.

### Modified Example of First Configuration Example of Additional Information Generating Unit

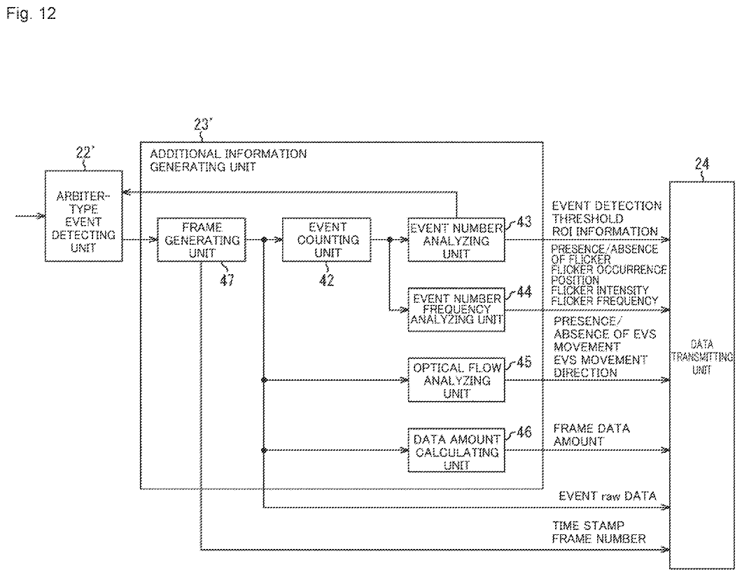

FIG. 12 is a block diagram illustrating a modified example of the first configuration example of the additional information generating unit 23. In an additional information generating unit 23′ illustrated in FIG. 12, the same reference signs will be assigned to configurations common to the additional information generating unit 23 illustrated in FIG. 7, and detailed description thereof will be omitted.

For example, the event detecting unit 22 and the additional information generating unit 23 illustrated in FIG. 7 described above are scanning types, and by outputting event data regardless of presence/absence of an occurrence of an event, one frame is configured. In contrast to this, the additional information generating unit 23′ is configured to be in correspondence with an arbiter-type event detecting unit 22′ that outputs event data only at a timing at which an event has occurred.

As illustrated in the drawing, the additional information generating unit 23′ is configured to include a frame generating unit 47, which is a configuration different from that of the additional information generating unit 23 illustrated in FIG. 7.

By complementing event data at a timing at which no event has occurred from event data output from the arbiter-type event detecting unit 22′, the frame generating unit 47 generates event data corresponding to one frame and supplies the generated event data to the event counting unit 42, the optical flow analyzing unit 45, and the data amount calculating unit 46. In addition, the frame generating unit 47 supplies event raw data to the data transmitting unit 24 and supplies a time stamp and a frame number of the generated frame to the data transmitting unit 24.

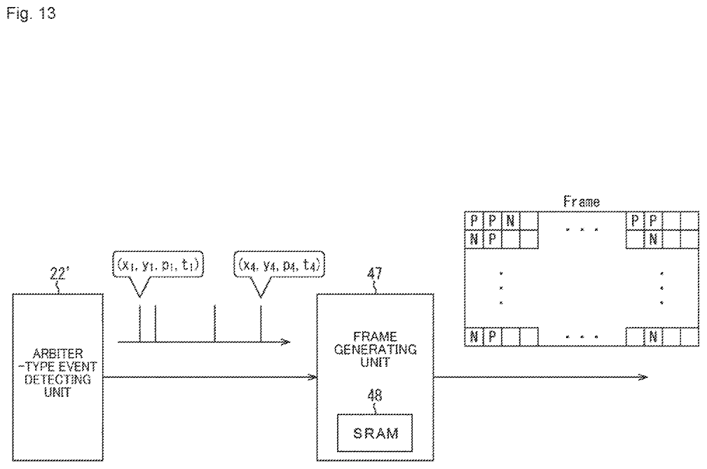

A process performed by the frame generating unit 47 will be described with reference to FIG. 13.

For example, when an n-th event occurs, the arbiter-type event detecting unit 22′ outputs n-th event data (xₙ, yₙ, pₙ, tₙ) representing coordinate information and time information at that timing. The frame generating unit 47 can temporarily store event data that has occurred in a period corresponding to a certain one frame in a static random access memory (SRAM) 48 in accordance with coordinate information. Then, when event data that has occurred in a period corresponding to the one frame is stored in the SRAM, the frame generating unit 47 can output such event data in the format of a frame.

In other words, the arbiter-type event detecting unit 22′ does not output event data in the concept of a so-called frame, and thus the arbiter-type EVS 12 needs to include a frame generating unit 47.

### Second Configuration Example of Additional Information Generating Unit

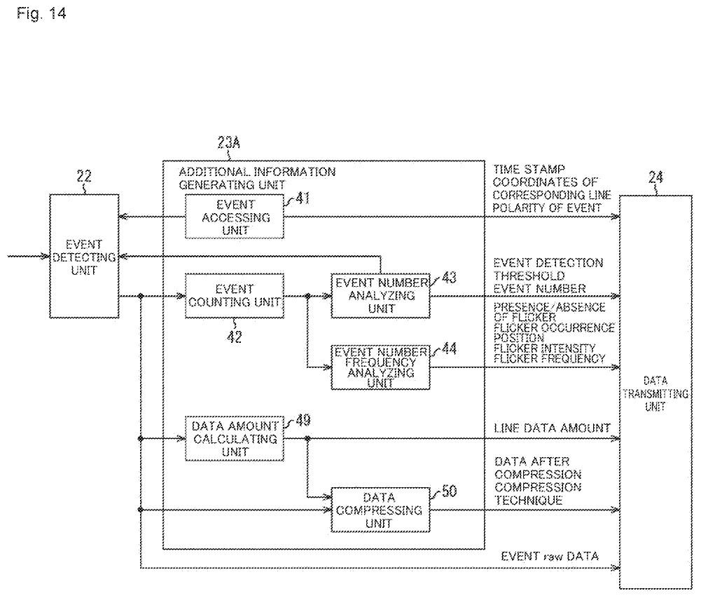

FIG. 14 is a block diagram illustrating a second configuration example of the additional information generating unit 23. In the additional information generating unit 23A illustrated in FIG. 14, the same reference signs will be assigned to configurations common to the additional information generating unit 23 illustrated in FIG. 7, and detailed description thereof will be omitted.

The additional information generating unit 23A illustrated in FIG. 14 generates line information added to a line as additional information that is additionally disposed in event data.

For example, the additional information generating unit 23A generates information of line information itself, identification information of this line, and flicker information as line information.

As the information of line information itself, a data amount (length) of the line information itself, an identifier used for identifying line information, and the like are used. As the identification information of this line, information representing a time stamp, coordinates (a position) of this line, a data amount (length) of this line, an event number (an activation rate/a degree of interest) of this line, an event detection threshold of this line, an event polarity of this line, a type of data (a type including a possibility other than an event), a compression technique, and the like is used. As the flicker information, information representing presence/absence of flicker of this line, an occurrence position of flicker of this line, an intensity of flicker of this line, and a frequency of flicker of this line is used.

In addition, the information of line information itself can be given by the data transmitting unit 24. A part of such information may be stored in the embedded data. This line may be one row or a plurality of rows. For example, line information assigned for every 10 rows is inserted as line information of a first row among the 10 rows.

The additional information generating unit 23A is configured to include an event accessing unit 41, an event counting unit 42, an event number analyzing unit 43, and an event number frequency analyzing unit 44, which is a configuration similar to that of the additional information generating unit 23 illustrated in FIG. 7. The additional information generating unit 23A is configured to include a data amount calculating unit 49 and a data compressing unit 50, which is a configuration different from that of the additional information generating unit 23 illustrated in FIG. 7.

The event accessing unit 41 generates a time stamp, coordinates of this line, and an event polarity of this line and supplies them to the data transmitting unit 24.

The event number analyzing unit 43 performs setting of an event detection threshold of this line by acquiring the event number of this line and supplies the event detection threshold of this line and the event number of this line to the data transmitting unit 24.

The event number frequency analyzing unit 44 acquires flicker information of this line representing presence/absence of flicker of this line, an occurrence position of the flicker of this line, an intensity of the flicker of this line, and a frequency of the flicker of this line and supplies the acquired flicker information to the data transmitting unit 24.

The data amount calculating unit 49 calculates a line data amount that is a data amount of this line that is a processing target on the basis of the event raw data supplied from the event detecting unit 22 and supplies the calculated line data amount to the data transmitting unit 24 and the data compressing unit 50.

The data compressing unit 50 performs a data compressing process of compressing the event raw data supplied from the event detecting unit 22 using a compression technique set in advance and supplies data after compression acquired as a result of the process to the data transmitting unit 24 together with the compression technique.

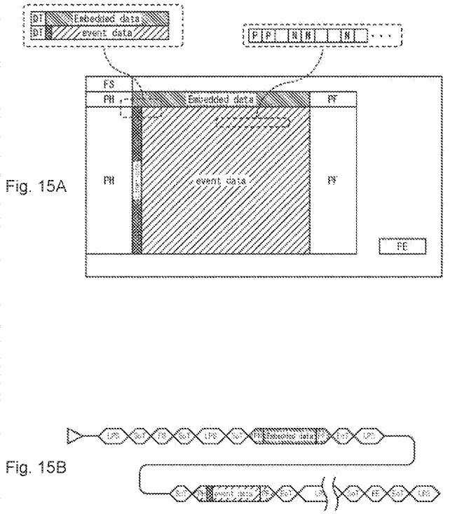

In this way, the additional information generating unit 23A can supply the time stamp, the coordinates of this line, the event polarity of this line, the event detection threshold of this line, the event number of this line, the flicker information of this line, the line data amount of this line, the data after compression, and the compression technique to the data transmitting unit 24. Then, the data transmitting unit 24 stores such information in a frame structure as illustrated in A of FIG. 15 as line information and can transmit the information to the data processing device 13 through the data bus 14 together with the event data. In B of FIG. 15, an output example of line information and event data output in compliance with the CSI-2 standard is illustrated.

In other words, as illustrated in FIG. 15, the data transmitting unit 24 stores line information at the beginning of an area storing data (that is, immediately after a packet header PH) in a long packet storing event data for each line.

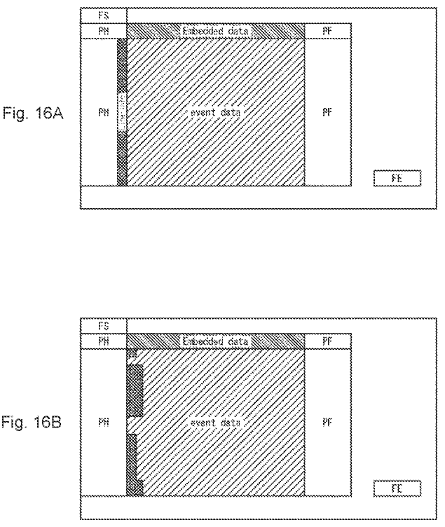

In addition, as illustrated in A of FIG. 16, line information may be configured to be included in the packet header PH. As illustrated in B of FIG. 16, a data length of the line information is arbitrary.

In this way, although an insertion position, an insertion number of times, and the like of the line information are arbitrary, when actual use is considered, it is preferable to arrange the line information at the beginning of the line. In other words, in a case in which line information is information used for identifying event data, by transmitting the line information before the event data, the processing efficiency of the event data on the data processing device 13 side can be improved. In addition, by transmitting the line information before the event data, the data processing device 13 can handle event data output from the EVS 12 while maintaining compatibility with a conventional standard.

The EVS 12 including the additional information generating unit 23A configured as above employs a frame structure in which line information is stored at a predetermined position of the line and can transmit the line information in an output format according to this frame structure. In other words, the EVS 12 stores frame information at the beginning of payload data and transmits the frame information in a frame structure in which event data is a part of the payload data. In this way, the versatility of the EVS 12 can be further improved.

Then, the data processing device 13 can determine a process to be performed on the event data on the basis of details described in line information by analyzing the packet header PH and the line information.

### <Modified Example of Second Configuration Example of Additional Information Generating Unit

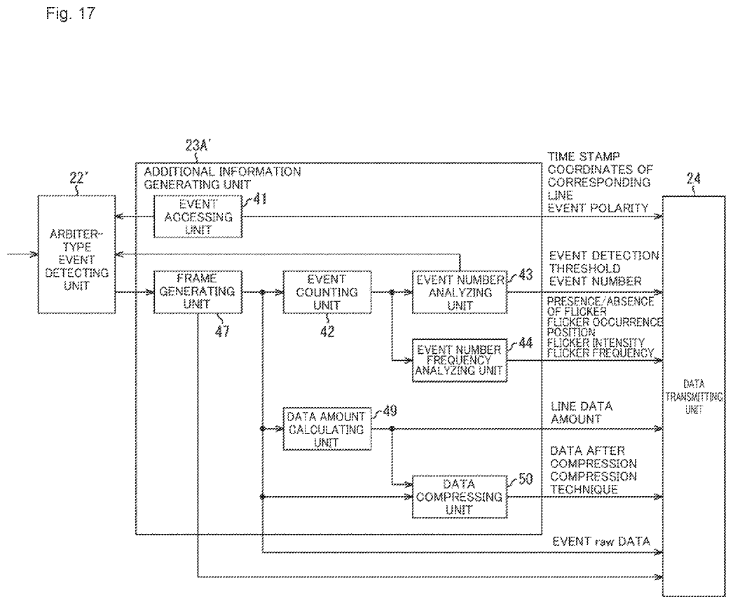

FIG. 17 is a block diagram illustrating a modified example of the second configuration example of the additional information generating unit 23. In an additional information generating unit 23A′ illustrated in FIG. 17, the same reference signs will be assigned to configurations common to the additional information generating unit 23A illustrated in FIG. 14, and detailed description thereof will be omitted.

For example, the event detecting unit 22 and the additional information generating unit 23A illustrated in FIG. 14 described above are scanning types, and by outputting event data regardless of presence/absence of an occurrence of an event, one frame is configured. In contrast to this, the additional information generating unit 23A′ is configured to be in correspondence with an arbiter-type event detecting unit 22′ that outputs event data only at a timing at which an event has occurred.

As illustrated in the drawing, the additional information generating unit 23A′ is configured to include a frame generating unit 47, which is a configuration different from that of the additional information generating unit 23A illustrated in FIG. 14. The frame generating unit 47, as described above with reference to FIG. 13, temporarily stores event data that has occurred in a period corresponding to certain one frame in the SRAM 48 and can output the event data that has occurred in the period corresponding to the one frame in the form of a frame.

### Third Configuration Example of Additional Information Generating Unit

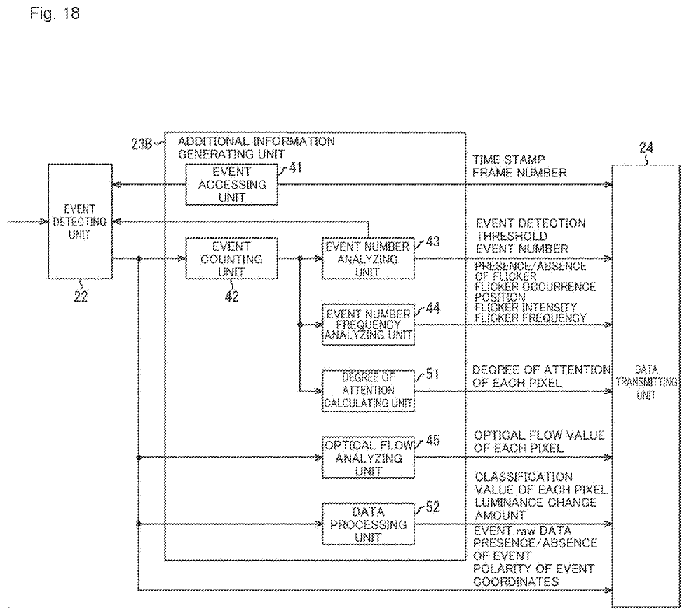

FIG. 18 is a block diagram illustrating a third configuration example of the additional information generating unit 23. In the additional information generating unit 23B illustrated in FIG. 18, the same reference signs will be assigned to configurations common to the additional information generating unit 23 illustrated in FIG. 7, and detailed description thereof will be omitted.

The additional information generating unit 23B illustrated in FIG. 18 generates pixel information added to a pixel as additional information that is additionally disposed in event data.

For example, the additional information generating unit 23B generates event information, flicker information, and information acquired from the event information as pixel information.

As the event information, a time stamp, coordinates, presence/absence of an event, a polarity of an event that has occurred, an event detection threshold, a luminance change amount, an event number (an activation rate), and the like are used. As the flicker information, information representing presence/absence of flicker, an occurrence position of the flicker, an intensity of the flicker, and a frequency of the flicker is used. The information acquired from the event information is information assigned to one pixel or an area over a plurality of pixels through an arithmetic operation based on the event information of each pixel, and information representing an optical flow, a degree of attention, a classification value, and the like is used.

The additional information generating unit 23B is configured to include an event accessing unit 41, an event counting unit 42, an event number analyzing unit 43, an event number frequency analyzing unit 44, and an optical flow analyzing unit 45, which is a configuration similar to that of the additional information generating unit 23 illustrated in FIG. 7. The additional information generating unit 23B is configured to include a degree of attention calculating unit 51 and a data processing unit 52, which is a configuration different from that of the additional information generating unit 23 illustrated in FIG. 7.

The optical flow analyzing unit 45 acquires an optical flow value of each pixel on the basis of event raw data supplied from the event detecting unit 22 and supplies the optical flow value to the data transmitting unit 24.

The degree of attention calculating unit 51 calculates a degree of attention of each pixel on the basis of an event number supplied from the event counting unit 42 and supplies the degree of attention to the data transmitting unit 24.

The data processing unit 52, for example, is configured using a neural network and the like and, by performing data processing using machine learning based on event raw data supplied from the event detecting unit 22, acquires a classification value and an amount of luminance change of each pixel and supplies them to the data transmitting unit 24.

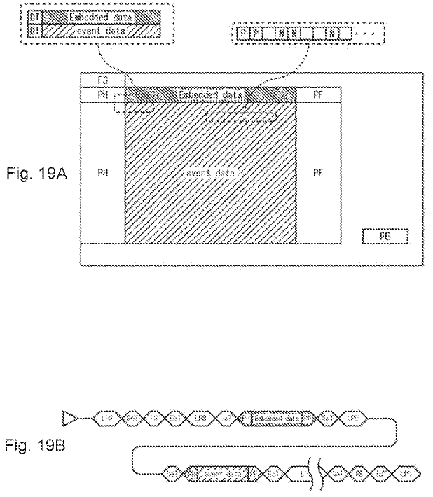

In this way, the additional information generating unit 23B can supply the time stamp, the frame number, the event detection threshold, the event number, the flicker information, the degree of attention of each pixel, the optical flow value of each pixel, the luminance change amount, the presence/absence of an event, and the polarity of the event to the data transmitting unit 24. Then, the data transmitting unit 24 embeds such information as pixel information in data of each pixel together with event data and can store the information in a frame structure as illustrated in A of FIG. 19. In B of FIG. 19, an output example of event data (data in which pixel information is embedded for each pixel) output in compliance with the CSI-2 standard is illustrated.

In addition, the data transmitting unit 24 can insert mode information representing an amount of data in bits is used as data corresponding to one pixel into the data type DT in accordance with a data amount of pixel information embedded in data of a pixel. For example, in a case in which the mode information is Mode 1, the data amount of a pixel is 2 bits of 0/−/+, and, in a case in which the mode information is Mode 2, the data amount of a pixel is a required data amount α in addition to the two bits of 0/−/+. In this way, the output of the EVS 12 can be flexibly changed in accordance with the use of an application and an information amount, accuracy, and the like that are necessary.

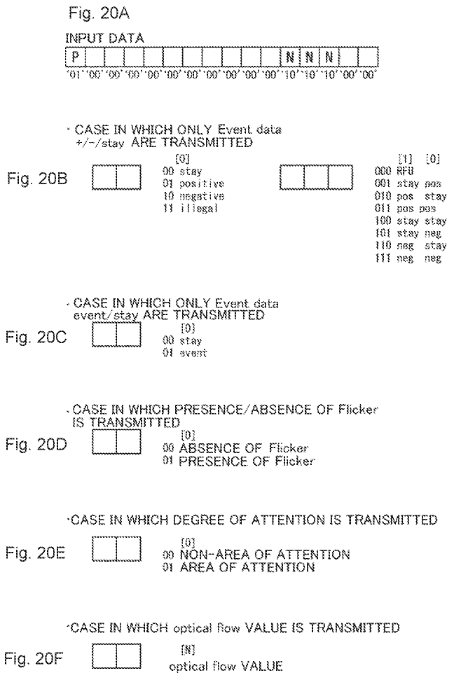

A transmission method of pixel information embedded in data of a pixel will be described with reference to FIG. 20.

In A of FIG. 20, one example of input data input from the event detecting unit 22 to the additional information generating unit 23B is illustrated. For example, “01” is input to event data of positivity, “10” is input to event data of negativity, and “00” is input to event data of stay having no change of luminance.

In B of FIG. 20, one example of data of a case in which only event data (+/−/stay) is transmitted using two bits or three bits is illustrated.

For example, in a case in which only the event data (+/−/stay) is transmitted using two bits, “01” is input to the event data of positivity, “10” is input to the event data of negativity, and “00” is input to the event data of stay. In addition, in a case in which only event data (+/−/stay) is transmitted using three bits, “001” is input to event data of stay⋅positivity, “010” is input to event data of positivity⋅stay, “011” is input to event data of positivity⋅positivity, “100” is input to event data of stay⋅stay, “101” is input to event data of stay⋅negativity, “110” is input to event data of negativity⋅stay, and “111” is input to event data of negativity⋅negativity.

In C of FIG. 20, one example of data of a case in which only event data (event/stay) is transmitted using two bits is illustrated. For example, “00” is input to event data of stay, and “01” is input to event data representing an occurrence of an event.

In D of FIG. 20, one example of a case in which pixel information representing presence/absence of flicker is transmitted using two bits is illustrated. For example, “00” is input to pixel information representing absence of flicker, and “01” is input to pixel information representing presence of flicker.

In E of FIG. 20, one example of data of a case in which pixel information representing a degree of attention is transmitted using two bits is illustrated. For example, “00” is input to the pixel information representing no area of attention, and “01” is input to the pixel information representing an area of attention.

In F of FIG. 20, one example of data of a case in which pixel information representing an optical flow value is transmitted using two bits is illustrated.

In accordance with such a data transmission method (a data format), the EVS 12 can select transmission of only event data and transmission of event data to which pixel information has been added. In addition, such selection (selection of a data length and details) can be fixed using a fuse, a ROM, or the like or can be configured to be dynamically selectable in units of frames. In the case of being dynamically selectable in units of frames, for example, frame information stored in the embedded data can be used.

The EVS 12 including the additional information generating unit 23B configured as above employs a frame structure in which pixel information is embedded in the event data and can transmit pixel information in an output format according to this frame structure. In this way, the EVS 12 can further improve versatility.

The data processing device 13 can be configured to include a circuit that determines presence/absence of switching of modes representing the amount of data corresponding to one pixel in bits on the basis of data acquired from the EVS 12 and generates a switching instruction signal to be transmitted to the EVS 12.

### Modified Example of Second Configuration Example of Additional Information Generating Unit

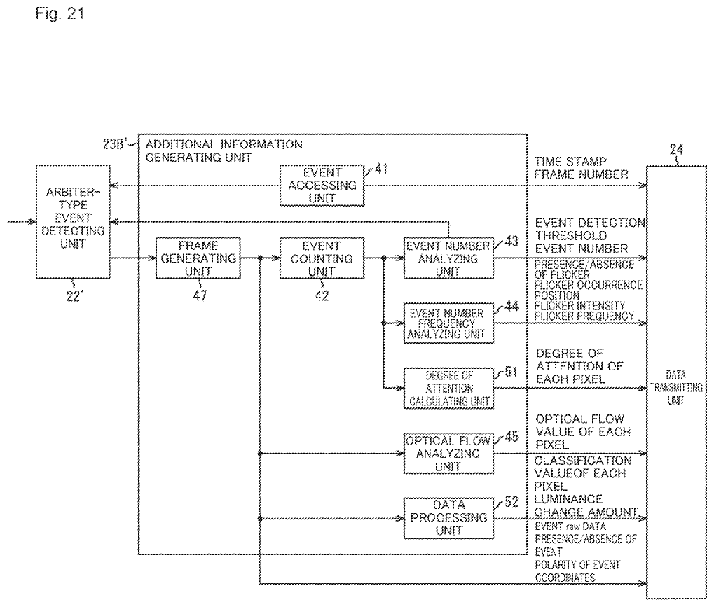

FIG. 21 is a block diagram illustrating a modified example of the second configuration example of the additional information generating unit 23. In an additional information generating unit 23B′ illustrated in FIG. 21, the same reference signs will be assigned to configurations common to the additional information generating unit 23B illustrated in FIG. 18, and detailed description thereof will be omitted.

For example, the event detecting unit 22 and the additional information generating unit 23B illustrated in FIG. 18 described above are scanning types, and by outputting event data regardless of presence/absence of an occurrence of an event, one frame is configured. In contrast to this, the additional information generating unit 23B′ is configured to be in correspondence with an arbiter-type event detecting unit 22′ that outputs event data only at a timing at which an event has occurred.

As illustrated in the drawing, the additional information generating unit 23B′ is configured to include a frame generating unit 47, which is a configuration different from that of the additional information generating unit 23B illustrated in FIG. 18. The frame generating unit 47, as described above with reference to FIG. 13, temporarily stores event data that has occurred in a period corresponding to certain one frame in the SRAM 48 and can output the event data that has occurred in the period corresponding to the one frame in the form of a frame.

### Configuration of Switching of Plurality of Physical Layers

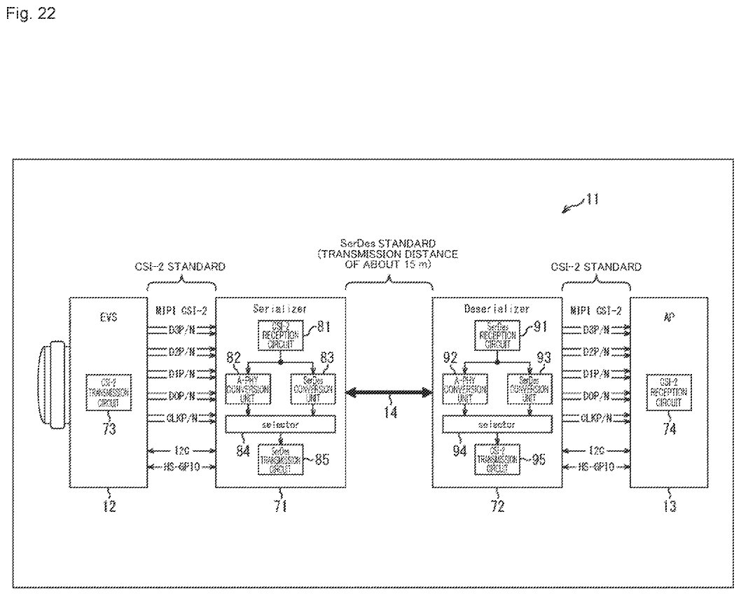

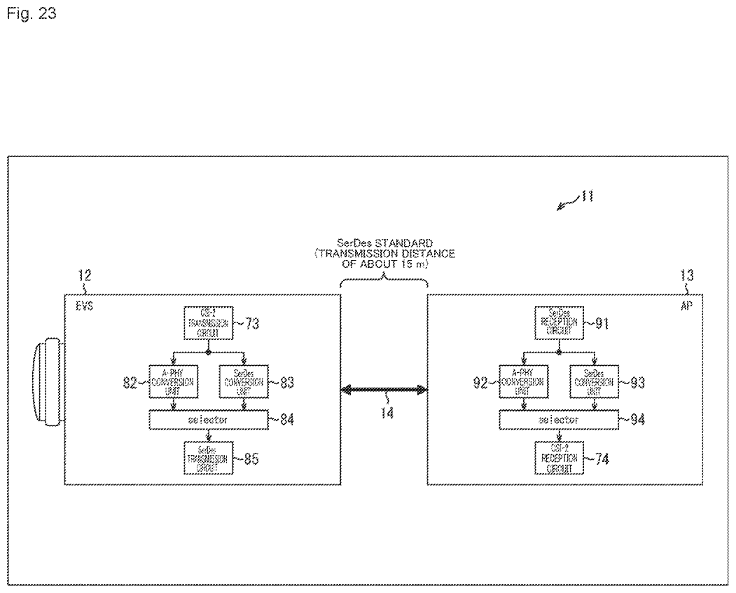

A configuration example of a sensor system 11 capable of switching a plurality of physical layers will be described with reference to FIGS. 22 and 23.

For example, the sensor system 11 can use A-PHY that is a SerDes standard of which a transmission distance is about 15 m and which is used for connecting a device inside of a vehicle as a physical layer for transmitting data between the EVS 12 and the data processing device 13. In addition, the sensor system 11 may be a physical layer other than A-PHY (for example, C-PHY, a D-PHY, or the like), and such physical layers are configured to be switchable.

FIG. 22 illustrates a configuration example of a sensor system 11 including a physical layer switching function in a serializer and a de-serializer.

As illustrated in FIG. 22, the sensor system 11 is configured to include a serializer 71 and a de-serializer 72. In the sensor system 11, between the EVS 12 and the serializer 71 and between the data processing device 13 and the de-serializer 72, communication is performed using the CSI-2 standard, and communication is configured to be performed between the serializer 71 and the de-serializer 72 through the data bus 14.

The EVS 12 includes a CSI-2 transmission circuit 73 corresponding to the data transmitting unit 24 illustrated in FIG. 1, and the data processing device 13 is configured to include a CSI-2 reception circuit 74 that corresponds to the data receiving unit 31 illustrated in FIG. 1.

The serializer 71 is configured to include a CSI-2 reception circuit 81, an A-PHY conversion unit 82, a SerDes conversion unit 83, a selector 84, and a SerDes transmission circuit 85.

In the serializer 71, the CSI-2 reception circuit 81 receives event data transmitted from the CSI-2 transmission circuit 73 of the EVS 12 and supplies the received event data to the A-PHY conversion unit 82 and the SerDes conversion unit 83. The A-PHY conversion unit 82 converts event data supplied from the CSI-2 reception circuit 81 into serial in accordance with the A-PHY standard and supplies the converted event data to the selector 84. The SerDes conversion unit 83 converts event data supplied from the CSI-2 reception circuit 81 into serial in accordance with a general SerDes standard other than the A-PHY into serial and supplies the converted event data to the selector 84. The selector 84, for example, in accordance with a predetermined selection signal, selects one of serially-converted event data supplied from the A-PHY conversion unit 82 and serially-converted event data supplied from the SerDes conversion unit 83 and supplies the selected event data to the SerDes transmission circuit 85. The SerDes transmission circuit 85 transmits the serially-converted event data selected by the selector 84 through the data bus 14.

The de-serializer 72 is configured to include a SerDes reception circuit 91, an A-PHY conversion unit 92, a SerDes conversion unit 93, a selector 94, and a CSI-2 transmission circuit 95.

In the de-serializer 72, the SerDes reception circuit 91 receives event data transmitted through the data bus 14 and supplies the received event data to the A-PHY conversion unit 92 and the SerDes conversion unit 93. The A-PHY conversion unit 92 performs de-serial conversion of the event data supplied from the SerDes reception circuit 91 in accordance with the A-PHY standard and supplies the converted event data to the selector 94. The SerDes conversion unit 93 performs de-serial conversion corresponding to the serial conversion using the SerDes conversion unit 83 for the event data supplied from the SerDes reception circuit 91 and supplies the converted event data to the selector 94. The selector 94, for example, in accordance with a predetermined selection signal, selects one of the event data supplied from the A-PHY conversion unit 92 and the event data supplied from the SerDes conversion unit 93 and supplies the selected event data to the CSI-2 transmission circuit 95. The CSI-2 transmission circuit 95 transmits the event data selected by the selector 94 to the CSI-2 reception circuit 74 of the data processing device 13.

By employing such a configuration, the sensor system 11 can perform switching between serial conversion according to the A-PHY standard and serial conversion according to a general SerDes standard in the serializer 71 and the de-serializer 72. Then, switching between the A-PHY conversion unit 82 and the SerDes conversion unit 83 and switching between the A-PHY conversion unit 92 and the SerDes conversion unit 93 are performed such that serial conversion of the same standard is performed in the serializer 71 and the de-serializer 72.

FIG. 23 illustrates a configuration example of a sensor system 11 in which a physical layer switching function is included in the EVS 12 and the data processing device 13.

As illustrated in FIG. 23, the EVS 12 is configured to include a CSI-2 transmission circuit 73, A-PHY conversion unit 82, a SerDes conversion unit 83, a selector 84, and a SerDes transmission circuit 85, and the data processing device 13 is configured to include a CSI-2 reception circuit 74, a SerDes reception circuit 91, an A-PHY conversion unit 92, a SerDes conversion unit 93, and a selector 94.

By employing such a configuration, the sensor system 11 can perform switching between serial conversion according to the A-PHY standard and serial conversion according to a general SerDes standard in the EVS 12 and the data processing device 13. Switching between the A-PHY conversion unit 82 and the SerDes conversion unit 83 and switching between the A-PHY conversion unit 92 and the SerDes conversion unit 93 are performed such that serial conversion of the same standard are performed in the EVS 12 and the data processing device 13.

### Configuration Example of Electronic Device

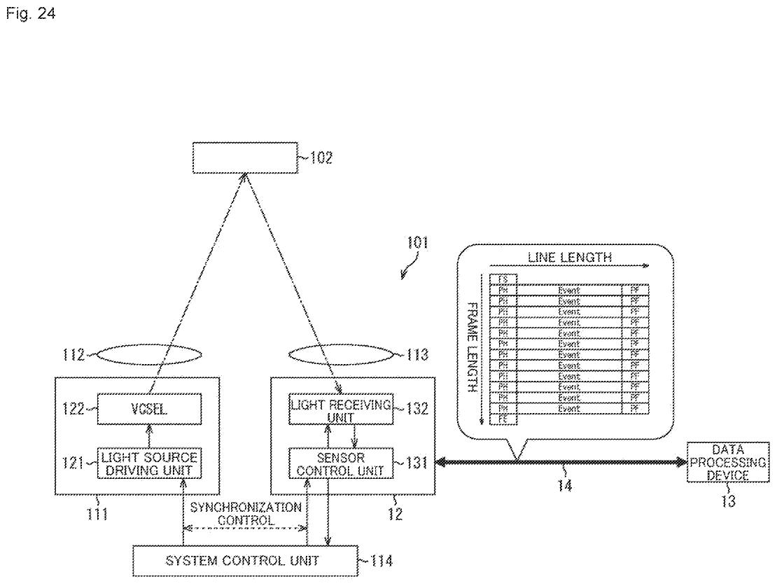

A configuration example of an electronic device including the EVS 12 will be described with reference to FIGS. 24 to 27.

FIG. 24 is a block diagram illustrating a configuration example of an electronic device 101 including the EVS 12.

As illustrated in FIG. 24, the electronic device 101 including the EVS 12 is configured to include a laser light source 111, an emission lens 112, an imaging lens 113, the EVS 12, and a system control unit 114.

The laser light source 111, as illustrated in FIG. 24, for example, is configured from a vertical cavity surface emitting laser (VCSEL) 122 and a light source driving unit 121 driving the VCSEL 122. However, the light source is not limited to the VCSEL 122, and various light sources such as a light emitting diode (LED) and the like may be used. In addition, the laser light source 111 may be any one of a point light source, a surface light source, and a line light source. In the case of a surface light source or a line light source, the laser light source 111, for example, may have a configuration in which a plurality of point light sources (for example, VCSELs) are one-dimensionally or two-dimensionally arranged. In addition, in this embodiment, the laser light source 111 may emit light of a wavelength band different from a wavelength band of visible light, for example, infrared light (IR) or the like.

The emission lens 112 is arranged on an exit surface side of the laser light source 111 and converts light exiting from the laser light source 111 into emission light of a predetermined spread angle.

The imaging lens 113 is arranged on a light reception surface side of the EVS 12 and forms an image according to incident light on the light reception surface of the EVS 12. In the incident light, reflective light that is emitted from the laser light source 111 and is reflected on the object 102 may be included.

The EVS 12, as illustrated in FIG. 24, for example, is configured from a light reception unit 132 in which pixels detecting an event (hereinafter, referred to as event pixels) are arranged in a two-dimensional lattice shape and a sensor control unit 131 generating frame data based on event data detected by event pixels by driving the light reception unit 132.

The system control unit 114, for example, is configured using a processor (CPU) and drives the VCSEL 122 through the light source driving unit 121. In addition, by controlling the EVS 12 in synchronization with control of the laser light source 111, the system control unit 114 acquires event data detected in accordance with emission/extinction of the laser light source 111.

For example, emission light exiting from the laser light source 111 is transmitted through the emission lens 112, and is projected onto the object 102. This projected light is reflected on the object 102. The light reflected on the object 102 is transmitted through the imaging lens 113 and is incident in the EVS 12. The EVS 12 receives reflective light reflected on the object 102, generates event data, and generates frame data that is one image on the basis of the generated event data.

The frame data generated by the EVS 12 is supplied to the data processing device 13 through the data bus 14. As illustrated in the drawing, in a configuration in which a frame header FS representing the beginning of the frame data, a line header PH representing the beginning of each piece of line data, a line footer PF representing the end of each piece of line data, line data Event interposed between the line header PH and the line footer PF, and a frame footer FE representing the end of the frame data are output, the frame data includes line data Event of all the line configuring the frame data between the frame header FS and the frame footer FE. In addition, in each piece of line data Event, in addition to event data for all the pixels configuring each line (for example, a positive event, a negative event, or no event), a y address representing a position of the line, flags representing whether this line data is a non-compressed data, whether the line data is data compressed using a certain coding system, and whether the line data is a processing result of a certain signal processing, and the like may be included.

The data processing device 13 formed from an application processor and the like executes predetermined processing such as image processing, recognition processing, and the like on the frame data input from the EVS 12.

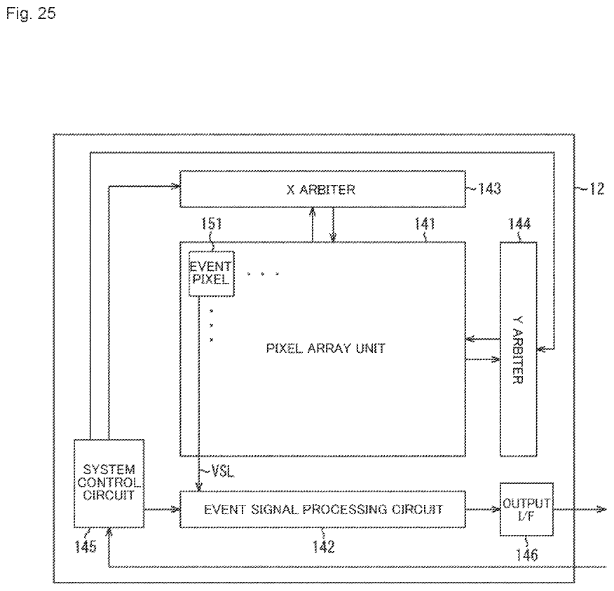

FIG. 25 is a block diagram illustrating a schematic configuration example of the EVS 12.

For example, a pixel array unit 141, an X arbiter 143, and a Y arbiter 144 illustrated in FIG. 25 corresponds to the luminance detecting unit 21 and the arbiter-type event detecting unit 22′ described above. In addition, as functions of the event signal processing circuit 142 and the system control circuit 145 illustrated in FIG. 25, the additional information generating unit 23′ described above is built in, and an output interface 146 illustrated in FIG. 25 corresponds to the data transmitting unit 24 described above.

As illustrated in FIG. 25, the EVS 12 is configured to include a pixel array unit 141, an X arbiter 143, a Y arbiter 144, an event signal processing circuit 142, a system control circuit 145, and an output interface (I/F) 146.

The pixel array unit 141 has a configuration in which a plurality of event pixels 151 each detecting an event on the basis of a luminance change of incident light are arranged in a two-dimensional lattice shape. In the following description, a row direction represents an arrangement direction of pixels of a pixel row (a horizontal direction in the drawing), and a column direction represents an arrangement direction of pixels of a pixel column (a vertical direction in the drawing).

Each event pixel 151 includes a photoelectric conversion element generating electric charge corresponding to luminance of incident light and, in a case in which a luminance change of the incident light is detected on the basis of an optical current flowing out from the photoelectric conversion element, outputs a request for reading from itself to the X arbiter 143 and the Y arbiter 144, and outputs an event signal indicating detection of an event in accordance with adjustment using the X arbiter 143 and the Y arbiter 144.

Each event pixel 151 detects presence/absence of an event in accordance with whether or not a change exceeding a predetermined threshold has occurred in an optical current corresponding to the luminance of incident light. For example, each event pixel 151 detects a luminance change exceeding the predetermined threshold (a positive event) or a luminance change being below the predetermined threshold (a negative event) as an event.

When an event is detected, the event pixel 151 outputs a request for requesting a permission for output of an event signal representing an occurrence of an event to each of the X arbiter 143 and the Y arbiter 144. Then, in a case in which a response representing a permission for output of an event signal has been received from each of the X arbiter 143 and the Y arbiter 144, the event pixel 151 outputs an event signal to the event signal processing circuit 142.

The X arbiter 143 and the Y arbiter 144 adjust requests for requesting output of an event signal supplied from each of a plurality of event pixels 151 and transmit a response based on a result of the adjustment (permission/no-permission for output of the event signal) and a reset signal for resetting detection of the event to the event pixel 151 that has output the requests.

The event signal processing circuit 142 generates and outputs event data by executing predetermined signal processing on an event signal input from the event pixel 151.

As described above, a change of the optical current generated by the event pixel 151 can be perceived also as a light amount change (luminance change) of light incident in the photoelectric conversion unit of the event pixel 151. Thus, an event can be regarded also as a light amount change (luminance change) of an event pixel 151 exceeding a predetermined threshold. In event data indicating an occurrence of an event, at least position information such as coordinates representing a position of the event pixel 151 in which a light amount change as an event has occurred is included. In the event data, in addition to the position information, polarity of the light amount change can be configured to be included.

In a series of event data output at a timing at which an event has occurred from the event pixel 151, as long as a space between pieces of event data is maintained to be that at the time of the occurrence of the event, the event data can be regarded to implicitly include time information representing a relative time at which the event has occurred.

However, when the space between pieces of event data is not maintained to be that at the time of the occurrence of the event in accordance with the event data being stored in a memory or the like, time information implicitly included in the event data disappears. For this reason, the event signal processing circuit 142 may include time information representing a relative time at which an event has occurred such as a time stamp in the event data before a space between pieces of event data is not maintained to be that at the time of the occurrence of the event.

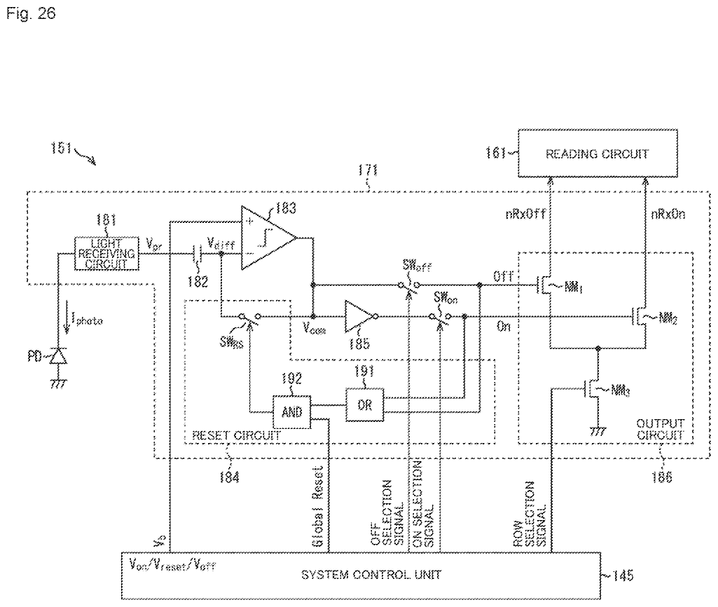

FIG. 26 is a circuit diagram illustrating a schematic configuration example of the event pixel 151. In FIG. 26, a configuration example of a case in which detection of a positive event and detection of a negative event are performed by one comparator in a time divisional manner is illustrated.

Here, in an event, for example, a positive event indicating that an amount of change of an optical current has exceeded an upper limit threshold and a negative event indicating that the amount of change is below a lower limit threshold are included. In that case, event data representing the occurrence of the event, for example, can be configured to include one bit representing the occurrence of the event and one bit representing the polarity of the event that has occurred. In addition, the event pixel 151 may be configured to have a function for detecting only a positive event or may be configured to have a function for detection only a negative event.

As illustrated in FIG. 26, the event pixel 151, for example, includes a photoelectric conversion unit PD and an address event detecting circuit 171. The photoelectric conversion unit PD, for example, is configured using a photodiode and the like and causes electric charge generated by performing photoelectric conversion of incident light to flow out as an optical current Iₚₕₒₜₒ. The optical current Iₚₕₒₜₒ that has flown out flows into the address event detecting circuit 171.

The address event detecting circuit 171 has a light receiving circuit 181, a memory capacity 182, a comparator 183, a reset circuit 184, an inverter 185, and an output circuit 186.

The light receiving circuit 181, for example, is configured from a current voltage converting circuit and converts an optical current Iₚₕₒₜₒ flowing out from the photoelectric conversion unit PD into a voltage Vₚᵣ. Here, a relation of a voltage Vₚᵣ with an intensity (luminance) of light is generally a logarithmic relationship. In other words, the light receiving circuit 181 converts an optical current Iₚₕₒₜₒ corresponding to the intensity of light emitted to the light reception surface of the photoelectric conversion unit PD into a voltage Vₚᵣ of a logarithmic relationship. However, the relation between the optical current Iₚₕₒₜₒ and the voltage Vₚᵣ is not limited to the logarithmic relationship.

The voltage Vₚᵣ corresponding to the optical current Iₚₕₒₜₒ output from the light receiving circuit 181 passes through the memory capacity 182 and then becomes an inverting (−) input that is a first input of the comparator 183 as a voltage V_{diff}. Generally, the comparator 183 is configured using a differential transistor pair. The comparator 183 has a threshold voltage V_{b} given from the system control circuit 145 as a non-inverting (+) input that is a second input and performs detection of a positive event and detection of a negative event in a time divisional manner. In addition, after detection of a positive event/a negative event, the event pixel 151 is reset by the reset circuit 184.

The system control circuit 145, as a threshold voltage V_{b}, outputs a voltage Vₒₙ in a stage in which a positive event is detected, outputs a voltage V_{off} in a stage in which a negative event is detected, and outputs a voltage Vᵣₑₛₑₜ in a stage in which resetting is performed in a time divisional manner. The voltage Vᵣₑₛₑₜ is set to a value between the voltage Vₒₙ and the voltage V_{off} and, more preferably, to a midpoint value between the voltage Vₒₙ and the voltage V_{off}. Here, the “midpoint value” has a meaning that it also includes a substantially midpoint value other than a case in which it is a precisely midpoint value, and presence of various variations generated in design or manufacturing are allowed.

In addition, the system control circuit 145 outputs an on-selection signal in a stage in which a positive event is detected to the event pixel 151, outputs an off-selection signal in a stage in which a negative event is detected, and outputs a global reset signal (Global Reset) in a stage in which resetting is performed. The on-selection signal is given to a selection switch SWₒₙ disposed between the inverter 185 and the output circuit 186 as a control signal thereof. The off-selection signal is given to a selection switch SW_{off} disposed between the comparator 183 and the output circuit 186 as a control signal thereof.

In a stage in which a positive event is detected, the comparator 183 compares the voltage Vₒₙ with a voltage V_{diff} and, when the voltage V_{diff} exceeds the voltage Vₒₙ, outputs positive event information On indicating that the amount of change of the optical current Iₚₕₒₜₒ has exceeded the upper limit threshold as a result of the comparison. The positive event information On is inverted by the inverter 185 and then is supplied to the output circuit 186 through the selection switch SWₒₙ.

In a stage in which a negative event is detected, the comparator 183 compares the voltage V_{off} with the voltage V_{diff} and, when the voltage V_{diff} is below the voltage V_{off}, outputs negative event information Off indicating that the amount of change of the optical current Iₚₕₒₜₒ has been below the lower limit threshold as a result of the comparison. The negative event information Off is supplied to the output circuit 186 through the selection switch SW_{off}.

The reset circuit 184 is configured to have a reset switch SW_{RS}, a two-input OR circuit 191, and a two-input AND circuit 192. The reset switch SW_{RS} is connected between the inverting (−) input terminal and an output terminal of the comparator 183 and, by being in an on (closed) state, selectively forms a short circuit between the inverting input terminal and the output terminal.

The OR circuit 191 has the positive event information On that has passed through the selection switch SWₒₙ and the negative event information Off that has passed through the selection switch SW_{off} as two inputs. The AND circuit 192 has an output signal of the OR circuit 191 as one input and the global reset signal given from the system control circuit 145 as the other input and, when one of the positive event information On or the negative event information Off is detected, and the global reset signal is in the active state, sets the reset switch SW_{RS} to be in the on (closed) state.

In this way, in accordance with the output signal of the AND circuit 192 being in the active state, the reset switch SW_{RS} forms a short circuit between the inverting input terminal and the output terminal of the comparator 183 and performs global resetting for the event pixel 151. In this way, a resetting operation is performed only for the event pixel 151 from which an event has been detected.

The output circuit 186 is configured to have a negative-event output transistor NM₁, a positive-event output transistor NM₂, and a current source transistor NM₃. The negative-event output transistor NM₁ has a memory (not illustrated) used for storing negative-event information Off in a gate part thereof. This memory is formed from gate parasitic capacitance of the negative-event output transistor NM₁.

Similar to the negative-event output transistor NM₁, the positive-event output transistor NM₂ has a memory (not illustrated) used for storing positive-event information On in a gate part thereof. This memory is formed from gate parasitic capacitance of the positive-event output transistor NM₂.

In a reading stage, the negative event information Off stored in the memory of the negative-event output transistor NM₁ and the positive event information On stored in the memory of the positive-event output transistor NM₂ are transmitted to the reading circuit 161 through an output line nRxOff and an output line nRxOn for each pixel row of the pixel array unit 141 in accordance with a row selection signal being given from the system control circuit 145 to the gate electrode of the current source transistor NM₃. The reading circuit 161, for example, is a circuit that is disposed inside of the event signal processing circuit 142 (see FIG. 25).

As described above, the event pixel 151 is configured to have an event detection function for performing detection of a positive event and detection of a negative event in a time divisional manner under the control of the system control circuit 145 by using one comparator 183.

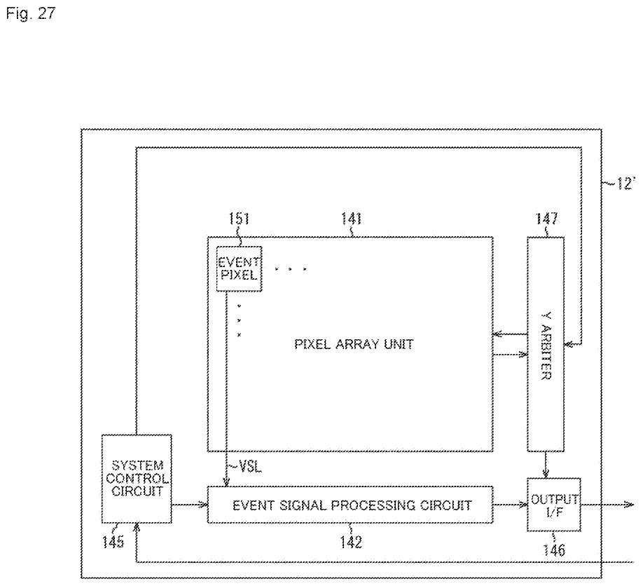

In FIG. 27, a configuration example of an EVS 12′ of a scanning type is illustrated.

As illustrated in FIG. 27, the EVS 12′ of the scanning type is configured to include an accessing unit 147 in place of the X arbiter 143 and the Y arbiter 144 included in the EVS 12 of the arbiter type illustrated in FIG. 25. In other words, the EVS 12′ includes a pixel array unit 141, an event signal processing circuit 142, a system control circuit 145, and an output interface 146, which is a configuration common to that of the EVS 12 illustrated in FIG. 25.

The accessing unit 147, for example, corresponds to the event accessing unit 41 illustrated in FIG. 7 and instructs each event pixel 151 of the pixel array unit 141 a timing at which event data is scanned.

### Configuration Example of Sensor System Including Plurality of Sensors

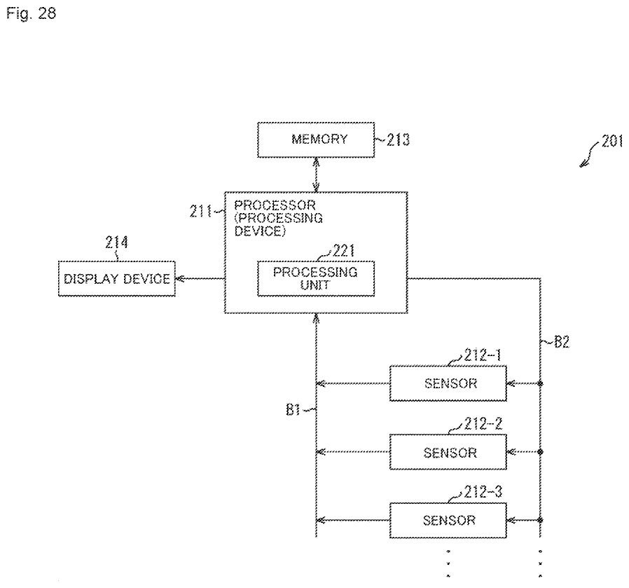

A configuration example of a sensor system including a plurality of sensors will be described with reference to FIGS. 28 to 33.

For example, as all of or one or more of sensors 212 illustrated in FIG. 28, the EVS 12 described above can be used. In addition, a processor 211 illustrated in FIG. 28 corresponds to the data processing device 13 described above, and a data bus B1 illustrated in FIG. 28 corresponds to the data bus 14 described above.

FIG. 28 is an explanatory diagram illustrating one example of the configuration of the sensor system 201 according to this embodiment. Examples of the sensor system 201 include a communication device such as a smartphone and a mobile body such as a drone (a device capable of performing an operation according to a remote operation or an autonomous operation) or a vehicle. In addition, application examples of the sensor system 201 are not limited to the examples illustrated above.

The sensor system 201, for example, has a processor 211, a plurality of sensors 212-1, 212-2, 212-3, . . . having a function for outputting an image, a memory 213, and a display device 214. Hereinafter, the plurality of sensors 212-1, 212-2, 212-3, . . . may be collectively referred to as “sensor 212”, or one of the plurality of sensors 212-1, 212-2, 212-3, . . . may be representatively referred to as “sensor 212”.

In FIG. 28, although the sensor system 201 having three or more sensors 212 is illustrated, the number of sensors 212 included in the system according to this embodiment is not limited to the example illustrated in FIG. 28. For example, the system according to this embodiment may have an arbitrary number of two or more sensors 212 such as two sensors 212 or three sensors 212. Hereinafter, for the convenience of description, in a case in which images are output from two sensors 212 among the plurality of sensors 212 included in the sensor system 201 or a case in which images are output from three sensors 212 among the plurality of sensors 212 included in the sensor system 201 will be described as an example.

The processor 211 and each of the plurality of sensors 212 are electrically connected to each other using one data bus B1. The data bus B1 is a transmission line of one signal that connects the processor 211 and each of the sensors 212. For example, data representing an image output from each of the sensors 212 (hereinafter, it may be referred to as “image data”) is transmitted from the sensor 212 to the processor 211 through the data bus B1.

In the sensor system 201, a signal transmitted using the data bus B1 is transmitted using an arbitrary standard in which a start and an end of transmitted data is identified using predetermined data, for example, such as the CSI-2 standard or the PCI Express. Examples of the predetermined data described above include a start packet of a frame in the CSI-2 standard, an end packet of a frame in the CSI-2 standard, and the like. Hereinafter, an example in which a signal transmitted using the data bus B1 is transmitted in accordance with the CSI-2 standard will be illustrated.

In addition, the processor 211 and each of the plurality of sensors 212 are electrically connected using a control bus B2 different from the data bus B1. The control bus B2 is a transmission line of another signal that connects the processor 211 and each of the sensors 212. For example, control information (to be described below) output from the processor 211 is transmitted from the processor 211 to the sensor 212 through the control bus B2. Hereinafter, similar to the data bus B1, an example in which a signal transmitted using the control bus B2 is transmitted in accordance with the CSI-2 standard will be illustrated.

In addition, in FIG. 28, although an example in which the processor 211 and each of the plurality of sensors 212 are connected using one control bus B2 is illustrated, the system according to this embodiment can be configured to take a configuration in which a control bus is disposed for each sensor 212. Furthermore, the processor 211 and each of the plurality of sensors 212 are not limited to a configuration in which control information (to be described below) is transmitted/received through the control bus B2, and, for example, a configuration in which control information (to be described below) is transmitted/received using radio communication of an arbitrary communication system capable of transmitting and receiving control information to be described below may be employed.

The processor 211 is configured using one or two or more processors configured using an arithmetic operation circuit such as a micro processing unit (MPU), various processing circuits, and the like. The processor 211 is driven using electric power supplied from an internal power supply (not illustrated) configuring the sensor system 201 such as a battery or electric power supplied from an external power supply of the sensor system 201.

The processor 211 is one example of a processing device according to this embodiment. The processing device according to this embodiment can be applied to an arbitrary circuit and an arbitrary device capable of performing the process performed by a processing unit to be described below (a process relating to a control method according to this embodiment).

The processor 211 performs “control relating to an image output from each of the plurality of sensors 212 connected to the data bus B1 through the data bus B1 (control relating to the control method according to this embodiment)”.

The control relating to an image, for example, is performed by a processing unit 221 included in the processor 211. In the processor 211, a specific processor (or a specific processing circuit) performing control relating to an image or a plurality of processors (or a plurality of processing circuits) has the role of the processing unit 221.

In addition, the processing unit 221 divides the function of the processor 211 for practical purposes. Thus, in the processor 211, for example, control relating an image according to this embodiment may be performed using a plurality of functional blocks. Hereinafter, a case in which the control relating to an image according to this embodiment is performed by the processing unit 221 will be described as an example.

By transmitting control information to each sensor 212, the processing unit 221 performs control relating to an image.

In control information according to this embodiment, for example, identification information representing the sensor 212 and information and processing commands for control are included. Examples of identification information according to this embodiment include arbitrary data that can be used for identifying the sensor 212 such as an ID set to the sensor 212 and the like.

The control information, as described above, for example, is transmitted through the control bus B2.

In addition, control information transmitted by the processing unit 221, for example, is recorded in a register (one example of a recording medium) included in each sensor 212. The sensor 212 outputs an image on the basis of control information stored in the register.

As the control relating to an image, the processing unit 221, for example, performs any one of control according to a first example illustrated in (1) described below to control according to a fourth example illustrated in (4) described below. In addition, an output example of an image in the sensor system 201 that is realized using the control relating to an image according to this embodiment will be described below.

### (1) First Example of Control Relating to Image: Control of Connection of Image

The processing unit 221 performs control of connection of a plurality of images output from the sensors 212.

More specifically, for example, by controlling a start of each frame and an end of each frame in a plurality of images output from the sensors 212, the processing unit 221 controls connection of the plurality of images.

The start of a frame in each of the sensors 212, for example, is controlled by the processing unit 221 controlling an output of a start packet of a certain frame in each of the sensors 212. An example of a start packet of a frame includes “Frame Start (FS) packet” in the CSI-2 standard. Hereinafter, a start packet of a frame may be referred to as “FS” or “FS packet”.

For example, by transmitting control information including data (first output information; one example of information for control) representing whether a start packet of a frame is output to the sensor 212, the processing unit 221 controls output of the start packet of the frame in the sensor 212. An example of the above-described data representing whether a start packet of a frame is output includes a flag that represents whether or not the start packet of the frame is output.

In addition, an end of a frame in each sensor 212, for example, is controlled by the processing unit 221 controlling output of an end packet of a frame in each sensor 212. An example of an end packet of a frame includes “Frame End (FE) packet” in the CSI-2 standard. Hereinafter, an end packet of a frame may be referred to as “FE” or “FE packet”.

For example, by transmitting control information including data (second output information; one example of information for control) representing whether an end packet of a frame is output to the sensor 212, the processing unit 221 controls output of the end packet of the frame in the sensor 212. An example of the above-described data representing whether an end packet of a frame is output includes a flag representing whether or not the end packet of the frame is output.

For example, as described above, start of a frame and end of a frame in each of a plurality of images output from the sensors 212 are controlled by the processing unit 221, and thus data representing images as below is output from the plurality of sensors 212.
Data including start packet of frame and end packet of fame
Data including only start packet of frame
Data including only end packet of frame
Data not including start packet of frame and end packet of frame

The processor 211 receiving a plurality of images transmitted from the plurality of sensors 212 through the data bus B1 recognizes that transmission of an image has been started in a certain frame on the basis of a start packet of the frame included in the received images.

In addition, the processor 211 recognizes that transmission of an image in a certain frame has ended on the basis of an end packet of the frame included in the received images.

In a case in which a start packet of a frame and an end packet of a frame are not included in a received image, the processor 211 does not recognize that transmission of an image has been started in a certain frame and transmission of an image in a certain frame has been ended. In addition, in the case described above, the processor 211 may recognize that transmission of an image in a certain frame is in the middle of the process.

Thus, in the processor 211 receiving a plurality of images transmitted from the plurality of sensors 212 through the data bus B1, processes as illustrated in the following (a) and (b) are realized. In addition, in a case in which another processing circuit capable of processing an image is connected to the data bus B1, the processing of images output from the plurality of sensors 212 may be performed by the other processing circuit. Hereinafter, a case in which the processing unit 221 included in the processor 211 performs processing of images output from the plurality of sensors 212 will be described as an example.

### (a) First Example of Processing of Images Output From Plurality of Sensors 212

In a case in which a start packet of a frame and an end packet of a frame are included in data transmitted from one sensor 212, the processing unit 221 processes an image output from this one sensor 212 as a single image.

### (b) Second Example of Processing of Images Output From Plurality of Sensors 212

“In a case in which a start packet of a frame is included in data transmitted from one sensor 212, and an end packet of a frame is included in data transmitted from another sensor 212 that has been received after reception of the data in which the start packet of the frame is included”, the processing unit 221 combines an image of the data in which the start packet of the frame is included and an image of the data in which the end packet of the frame is included.

In addition, “in the above-described case of the second example, before data in which an end packet of a frame is included is received, data, in which a start packet of a frame and an end packet of a frame are not included, transmitted from one or two or more other sensors 212 is received, the processing unit 221 combines an image of the data in which a start packet of a frame is included, an image of the data in which a start packet of a frame and an end packet of a frame are not included, and an image of the data in which the end packet of a frame is included.

The processing unit 221 combines images transmitted from a plurality of sensors 212 as described above on the basis of a start packet of a frame and an end packet of a frame, whereby connection of a plurality of images transmitted from the plurality of sensors 212 is realized.

The control of connection of a plurality of images according to this embodiment is not limited to the example described above.

For example, in addition, by controlling assignment of identifiers to a plurality of images output from the sensors 212, the processing unit 221 can control connection of the plurality of images.

Here, an identifier according to this embodiment is data that can be used for identifying an image output from the sensor 212. An example of the identifier according to this embodiment includes one or both of a virtual channel (VC) value (it may be referred to as “VC number”) defined in the CSI-2 standard and a data type (DT) value defined in the CSI-2 standard. In addition, the identifier according to this embodiment is not limited to the example described above and may be arbitrary data that can be used for identifying an image in control of connection of a plurality of images transmitted from a plurality of sensors 212.

For example, by transmitting control information including data (third output information; one example of information for control) representing identifiers of images to the sensor 212, the processing unit 221 controls assignment of identifiers to images output from sensors 212.

In a case in which identifiers are included in data transmitted from the sensors 212, the processing unit 221 recognizes images to which different identifiers are assigned in a certain frame as different images. In other words, in a case in which identifiers are included in data transmitted from the sensors 212, the processing unit 221 does not connect images to which different identifiers are assigned.

Thus, in addition to the control of start of a frame and end of a frame, by further controlling assignment of identifiers to a plurality of images output from the sensors 212, the processing unit 221 can realize more diverse control of connection of images than a case in which start of a frame and end of a frame are controlled.

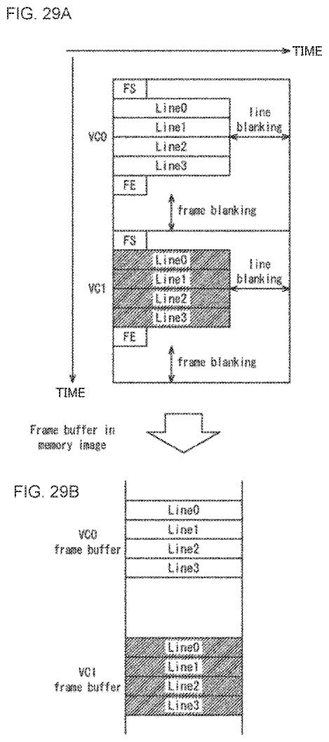

FIGS. 29 to 33 are explanatory diagrams for describing one example of control relating to an image in the processor 211 configuring the sensor system 201 according to this embodiment. Each of FIGS. 29 to 33 illustrates one example of a result of control of connection of images in the processor 211.

### (1-1) First Example of Result of Control of Connection of Images: FIG. 29

An illustrated in FIG. 29 illustrates one example of data corresponding to a certain frame that has been acquired by the processor 211 from two sensors 212 through the data bus B1. A illustrated in FIG. 29 illustrates an example in which data represented below is received from one sensor 212 and another sensor 212.
One sensor 212: data including image data of each line, a start packet of a frame, an end packet of a frame, and a VC value “0” (one example of the identifier; hereinafter the same)
Another sensor 212: data including image data of each line, a start packet of a frame, an end packet of a frame, and a VC value “1” (one example of the identifier; hereinafter the same)

In addition, B illustrated in FIG. 29 illustrates a memory image of a case in which the data illustrated in A of FIG. 29 is stored in a frame buffer of the memory 213. Furthermore, the data illustrated in A of FIG. 29 may be stored in another recording medium such as a recording medium included in the processor 211.

In a case in which the data as illustrated in A of FIG. 29 has been received, the processing unit 221, for example, as illustrated in B of FIG. 29, records images separately into frame buffers of respective VC values.

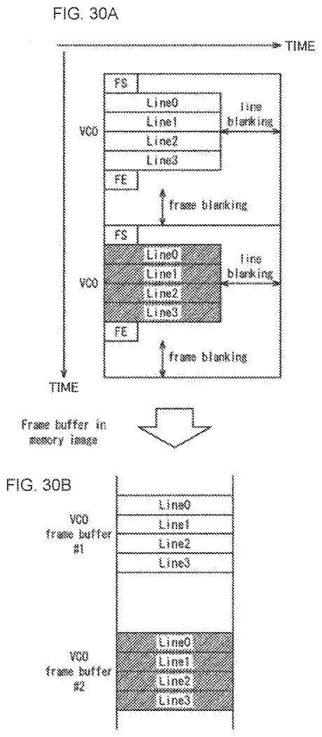

### (1-2) Second Example of Result of Control of Connection of Images: FIG. 30

An illustrated in FIG. 30 illustrates one example of data corresponding to a certain frame that is acquired by the processor 211 from two sensors 212 through the data bus B1. A illustrated in FIG. 30 illustrates an example in which data represented below has been received from one sensor 212 and another sensor 212.
One sensor 212: Data including image data of each line, a start packet of a frame, an end packet of a frame, and a VC value “0”
Another sensor 212: Data including image data of each line, a start packet of a frame, an end packet of a frame, and a VC value “0”

In a case in which the data as represented in A of FIG. 30 has been received, the processing unit 221, for example, as illustrated in B of FIG. 30, records images in a frame buffer used for the same VC value. The storage of images illustrated in B of FIG. 30, for example, is realized using a double buffer or the like.

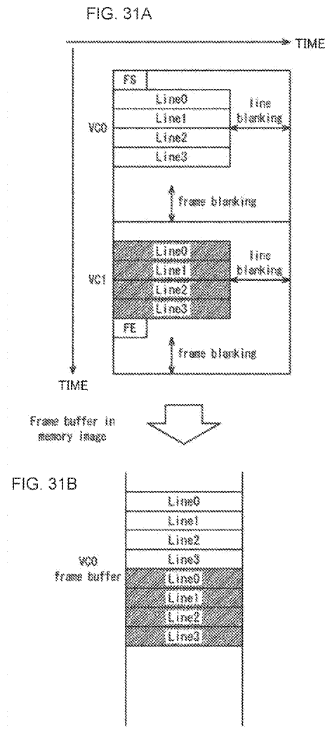

### (1-3) Third Example of Result of Control of Connection of Images: FIG. 31

An illustrated in FIG. 31 illustrates one example of data corresponding to a certain frame that is acquired by the processor 211 from two sensors 212 through the data bus B1. A illustrated in FIG. 31 illustrates an example in which data represented below has been received from one sensor 212 and another sensor 212.
One sensor 212: Data including image data of each line, a start packet of a frame, and a VC value “0”
Another sensor 212: Data including image data of each line, an end packet of a frame, and a VC value “0”

In a case in which the data illustrated in A of FIG. 31 has been received, the processing unit 221, for example, as illustrated in B of FIG. 31, records images in a frame buffer by connecting the two images in a vertical direction.

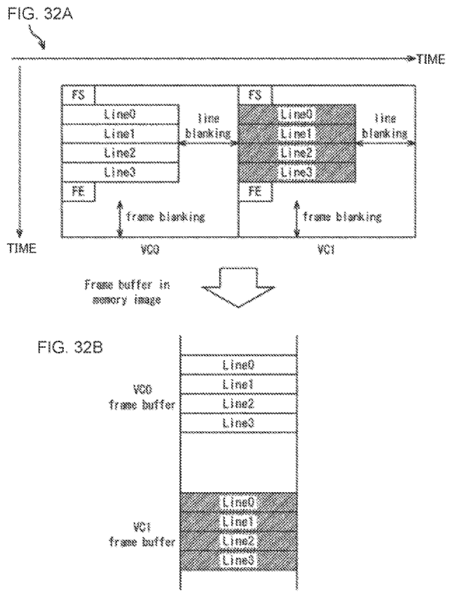

### (1-4) Fourth Example of Result of Control of Connection of Images: FIG. 32

An illustrated in FIG. 32 illustrates one example of data corresponding to a certain frame that is acquired by the processor 211 from two sensors 212 through the data bus B1. A illustrated in FIG. 32 illustrates an example in which data represented below has been received from one sensor 212 and another sensor 212.
One sensor 212: Data including image data of each line, a start packet of a frame, an end packet of a frame, and a VC value “0”
Another sensor 212: Data including image data of each line, a start packet of a frame, an end packet of a frame, and a VC value “1”

In a case in which the data illustrated in A of FIG. 32 has been received, the processing unit 221, for example, as illustrated in B of FIG. 32, records images separately into frame buffers of respective VC values.

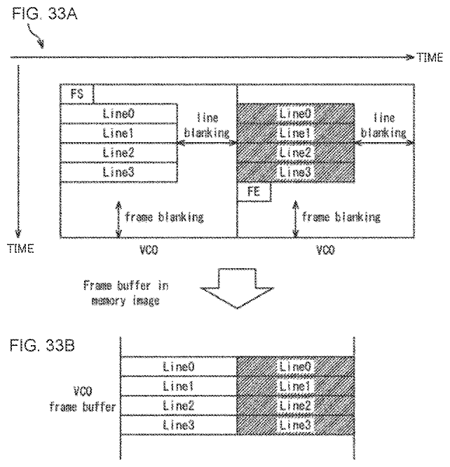

### (1-5) Fifth Example of Result of Control of Connection of Images: FIG. 33

An illustrated in FIG. 33 illustrates one example of data corresponding to a certain frame that is acquired by the processor 211 from two sensors 212 through the data bus B1. A illustrated in FIG. 33 illustrates an example in which data represented below has been received from one sensor 212 and another sensor 212.
One sensor 212: Data including image data of each line, a start packet of a frame, and a VC value “0”
Another sensor 212: Data including image data of each line, an end packet of a frame, and a VC value “0”

In a case in which the data illustrated in A of FIG. 33 has been received, the processing unit 221, for example, as illustrated in B of FIG. 33, records images in a frame buffer by connecting the two images in a horizontal direction.

In accordance with control of connection of images in the processing unit 221 of the processor 211, for example, as illustrated in FIGS. 29 to 33, images are selectively connected. In addition, it is apparent that an example of a result of control of connection of images using the processing unit 221 of the processor 100 according to this embodiment is not limited to the examples illustrated in FIGS. 29 to 33.

### (2) Second Example of Control Relating to Images: Control of Output Images

The processing unit 221 performs control of images output from the sensors 212. An example of control of images output from the sensors 212 according to this embodiment includes one or both of control of sizes of images output from the sensors 212 and control of frame rates of images output from a plurality of sensors 212.

The processing unit 221, for example, controls images output from sensors 212 by transmitting control information including one or both (one example of information for control) of data representing an image size and data representing a frame rate to the sensors 212.

### (3) Third Example of Control Relating to Images: Control of Output Timings of Images

The processing unit 221 controls output timings of images output from the image sensors.

The processing unit 221, for example, controls output timings of images output from sensors 212 by transmitting control information including data (one example of information for control) representing an output delay amount until an image is output after an output command for the image is received to the sensors 212.

### (4) Fourth Example of Control Relating to Images

The processing unit 221 may perform two or more types of control among the control according to the first example illustrated in (1) described above to the control according to the third example illustrated in (3) described above.

As control relating to images, the processing unit 221, for example, performs the control according to the first example illustrated in (1) described above to the control according to the fourth example illustrated in (4) described above as the control relating to images.

For example, by including the processing unit 221, the processor 211 performs the processing relating to the control relating to images as described above (processing according to the control method according to this embodiment).

In addition, the processing performed by the processor 211 is not limited to the processing relating to the control relating to images as described above.

For example, the processor 211 can perform various kinds of processing such as processing relating to control of recording image data on a recording medium such as the memory 213 illustrated with reference to FIGS. 29 to 33, processing relating to control of display of images on a display screen of the display device 214, and processing of executing arbitrary application software. An example of the processing relating to the control of recording, for example, includes “processing of delivering control data including a recording command and data to be recorded on a recording medium to the recording medium such as the memory 213”. In addition, an example of the process relating to the control of display includes “processing of delivering control data including a display command and data to be displayed on a display screen to a display device such as the display device 214”.

The sensor 212 is an image sensor. The image sensor according to this embodiment, for example, includes an imaging device such as a digital still camera, digital video camera, or a stereo camera and an arbitrary sensor device such as an infrared sensor or a distance image sensor and has a function of outputting a generated image. Here, the image generated by the sensor 212 corresponds to data representing a sensing result acquired by the sensor 212.

The sensor 212, for example, as illustrated in FIG. 28, is connected to a data bus B1 to which other sensors 212 are connected.

The sensor 212 outputs an image on the basis of the control information. As described above, the control information is transmitted from the processor 211, and the sensor 212 receives the control information through the control bus B2.

### One Example of Transmission System

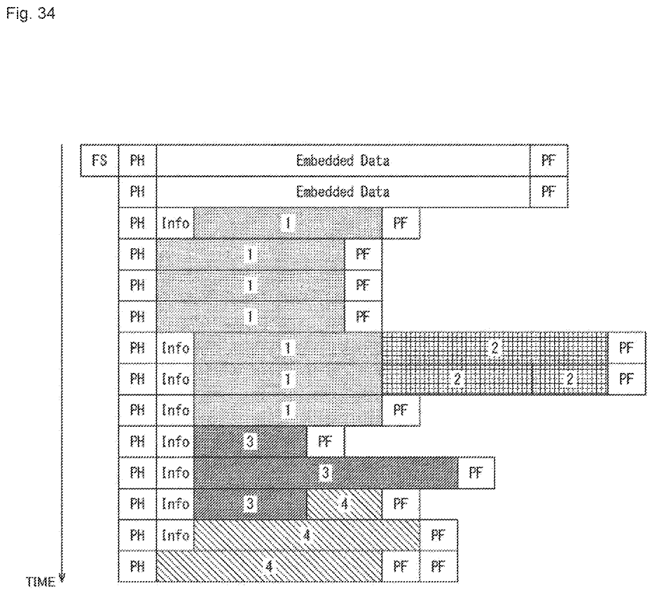

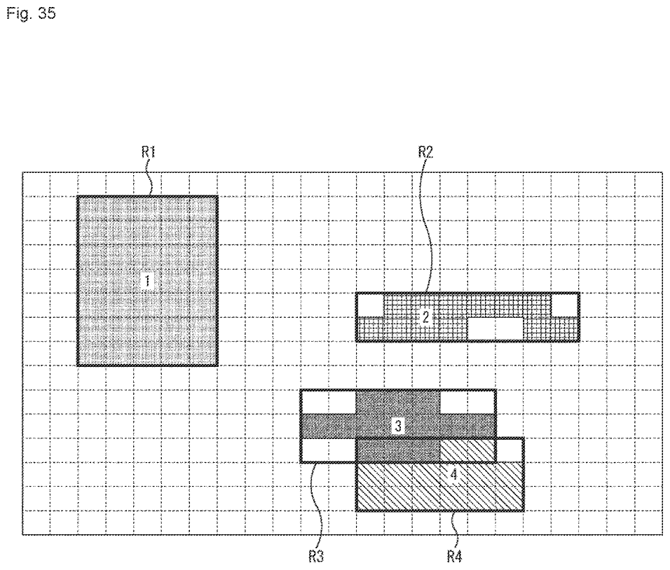

One example of a transmission system from the sensor 212 to the processor 211 will be described with reference to FIGS. 34 and 35.

The sensor 212 transmits area information and area data with being stored in a payload of a packet for each row. For example, in the sensor 212, the additional information generating unit 23 sets area information corresponding to an area set for an image formed from event data for each row of the image, the set area information and event data that becomes area data corresponding to the area are transmitted for each row. The sensor 212, for example, transmits the area information and the area data of each row in a predetermined order such as an ascending order or a descending order of the y coordinate value. In addition, the sensor 212 may transmit area information and area data of each row in a random order. Here, the area information is data (a data group) used for identifying an area set for an image on the reception device side. In the area information, for example, information representing a position of the row, identification information of an area included in the row, information representing a position of a column of an area included in the row, and information representing a size of an area included in the row are included.

FIG. 34 is an explanatory diagram illustrating one example of data transmitted using a first transmission system according to the transmission method according to this embodiment. FIG. 34 illustrates “an example in which area information and area data corresponding to each of Area 1, Area 2, Area 3, and Area 4 illustrated in FIG. 35 (event data of Area 1, event data of Area 2, event data of Area 3, and event data of Area 4) are stored in a payload of a long packet of MIPI and are transmitted for each row”.

“FS” represented in FIG. 34 is a Frame Start (FS) packet in the MIPI CSI-2 standard, and “FE” represented in FIG. 34 is a Frame End (FE) packet in the MIPI CSI-2 standard (this is the same in other diagrams).

“Embedded Data” represented in FIG. 34 is data that can be embedded in a header or a footer of transmitted data. An example of “Embedded Data” includes additional information that is additionally transmitted by the sensor 212. Hereinafter, embedded data may be referred to as “EBD”.

An example of the additional information according to this embodiment includes one or two or more of information representing a data amount of an area, information representing a size of an area, and information representing a priority level of an area.

An example of the information representing a data amount of an area includes data of an arbitrary format that can be used for identifying the data amount of the area such as “data representing the number of pixels included in the area (or a data amount of the area) and data representing a data amount of the header”. By transmitting information representing a data amount of the area as “Embedded Data” illustrated in FIG. 34, a reception device can identify a data amount of each area. In other words, by transmitting information representing a data amount of the area as “Embedded Data” illustrated in FIG. 34, even in a case in which a reception device does not have a function for calculating a data amount of each area on the basis of the area information, the reception device can identify the data amount of each area.

An example of the information representing a size of the area includes data of an arbitrary format that can be used for identifying the size of the area such as “data representing a rectangular area including the area (for example, data representing the number of pixels in a horizontal direction and the number of pixels in the vertical direction in this rectangular area)”.

The information representing a priority level of an area, for example, is data used in processing of data of the area. For example, a priority level represented by the information representing a priority level of an area is used for determining the order of areas to be processed, processing of a case in which set areas such as Area 3 and Area 4 illustrated in FIG. 35 overlap each other, and the like.

In addition, the additional information according to this embodiment is not limited to the example described above. Examples of the additional information according to this embodiment include various types of data such as exposure information representing an exposure value or the like of an image sensor device, gain information representing a gain of an image sensor device, and the like. Each of the exposure value represented by the exposure information and the gain represented by the gain information is set in the image sensor device in accordance with control using the processor 211 through the control bus B2.

FIG. 35 is an explanatory diagram for describing one example of embedded data transmitted using the first transmission system according to the transmission method according to this embodiment. FIG. 35 illustrates an example in which information representing a size of an area is transmitted as “Embedded Data” represented in FIG. 34, and the information representing the size of a transmitted area is data representing a minimal rectangular area including the area. In addition, FIG. 35 illustrates an example in which four areas including Area 1, Area 2, Area 3, and Area 4 are set.

By transmitting information representing a size of an area as “Embedded Data” illustrated in FIG. 34, a reception device can identify a minimal rectangular area including Area 1 denoted by R1 of FIG. 35, a minimal rectangular area including Area 2 denoted by R2 of FIG. 35, a minimal rectangular area including Area 3 denoted by R3 of FIG. 35, and a minimal rectangular area including Area 4 denoted by R4 of FIG. 35. In other words, in accordance with transmission of the information representing a size of an area as “Embedded Data” illustrated in FIG. 34, even in a case in which a reception device does not have a function for identifying a minimal rectangular area including each area on the basis of the area information, the reception device can be caused to identify an area of a minimal rectangular area including each area on the basis of the area information. In addition, it is apparent that the information representing a size of an area is not limited to the data representing a minimal rectangular area including each area.

An example of the information representing a priority level of an area includes data of an arbitrary format that can be used for identifying a priority level of an area such as data in which ROI IDs are aligned in order of the highest to lowest priority level or data in which ROI IDs are aligned in order of the lowest to highest priority level. By transmitting the information representing a priority level of an area as “Embedded Data” illustrated in FIG. 34, a reception device, for example, can identify a processing order of areas and an area to be processed with priority. In other words, by transmitting the information representing a priority level of an area as “Embedded Data” illustrated in FIG. 34, the processing on areas can be controlled in the reception device.

In addition, it is apparent that examples of the information representing a data amount of an area, the information representing a size of an area, and the information representing a priority level of an area, which are transmitted as “Embedded Data” illustrated in FIG. 34, are not limited to the examples described above.

“PH” represented in FIG. 34 is a packet header of a long packet. Here, the packet header of the long packet according to the first transmission system may function as data (change information) representing whether or not information included in the area information has been changed from the area information included in a packet that has been previously transmitted. In other words, “PH” represented in FIG. 34 can be regarded as one piece of data that represents a data type of a long packet.

As one example, in a case in which information included in the area information has been changed from the area information included in a packet that has been previously transmitted, the sensor 212 sets “PH” to “0×38”. In this case, the sensor 212 stores the area information in the payload of the long packet.

As another example, in a case in which information included in the area information has not been changed from the area information included in a packet that has been previously transmitted, the sensor 212 sets “PH” to “0×39”. In this case, the sensor 212 does not store the area information in the payload of the long packet. In other words, in a case in which information included in the area information has not been changed from the area information included in a packet that has been previously transmitted, the sensor 212 does not transmit the area information.

In addition, it is apparent that data set to “PH” is not limited to that of the example illustrated above.

“Info” represented in FIG. 34 is area information stored in a payload (this similarly applies also to other drawings) As illustrated in FIG. 34, area information is stored in a beginning part of the payload. For example, the area information may be referred to as “ROI Info”.

“1”, “2”, “3”, and “4” represented in FIG. 34 respectively correspond to area data of Area 1, area data of Area 2, area data of Area 3, and area data of Area 4 that are stored in the payload (this similarly applies also to other diagrams). In addition, although each piece of the area data is illustrated to be delimited in FIG. 34, this represents a delimiter for practical purposes, and there is no delimiter in data stored in the payload (this similarly applies also to other drawings). For example, the area data may be referred to as “ROI DATA”.

### Usage Example of Image Sensor

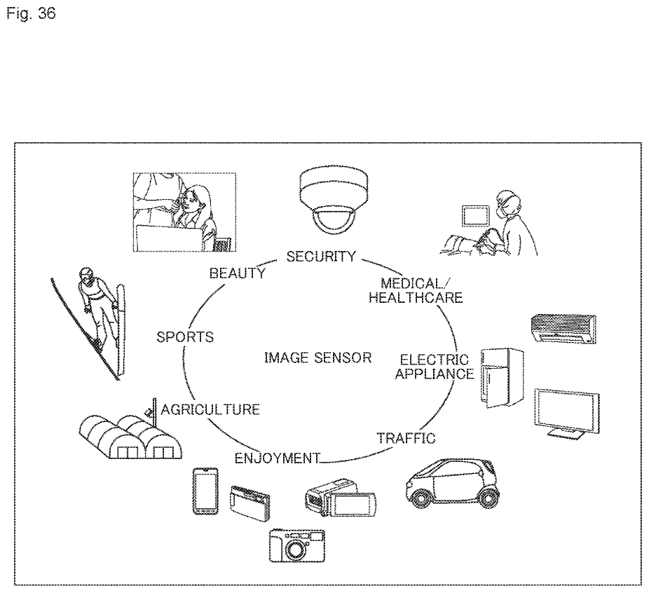

FIG. 36 is a usage example in which the image sensor (the EVS 12) described above is used.

The above-described image sensor, for example, can be used in various cases for sensing light such as visible light, infrared light, ultraviolet light, and X-ray as will be described.
Devices that capture images used for viewing, such as digital cameras and mobile devices with camera functions
Devices used for transportation, such as in-vehicle sensors that capture front, rear, surrounding, and interior view images of automobiles, monitoring cameras that monitor traveling vehicles and roads, ranging sensors that measure a distance between vehicles, and the like, for safe driving such as automatic stop, recognition of a driver's condition, and the like
Devices used for home appliances such as TVs, refrigerators, and air conditioners in order to capture an image of a user's gesture and perform device operations in accordance with the gesture
Devices used for medical treatment and healthcare, such as endoscopes and devices that perform angiography by receiving infrared light
Devices used for security, such as monitoring cameras for crime prevention and cameras for personal authentication
Devices used for beauty, such as a skin measuring device that captures images of the skin and a microscope that captures images of the scalp
Devices used for sports, such as action cameras and wearable cameras for sports applications
Devices used for agriculture, such as cameras for monitoring conditions of fields and crops

### Combination Example of Configuration

The present disclosure can also be configured as follows.

1

An image sensor including: an event detecting unit that detects an occurrence of an event that is a luminance change of light received by a photodiode; and a data transmitting unit that sets event data representing details of the event as a part of payload data and transmits pixel information added to data of each pixel including the photodiode in a frame structure in which the pixel information is embedded in the event data.

2

The image sensor described in (1) above, in which the data transmitting unit inserts information representing an amount of data used in data corresponding to one pixel into a data type in accordance with a data amount of the pixel information embedded in the event data.

3

The image sensor described in (1) or (2) above, in which the pixel information includes a time stamp or a frame number relating to the event data.

4

The image sensor described in any one of (1) to (3) above, in which the pixel information includes an event detection threshold or an event number.

5

The image sensor described in any one of (1) to (4) above, in which the pixel information includes flicker information generated on the basis of the event data.

6

The image sensor described in any one of (1) to (5) above, in which the pixel information includes an optical flow value of each pixel generated on the basis of the event data.

7

The image sensor described in any one of (1) to (6), in which the pixel information includes a degree of attention of each pixel.

8

The image sensor described in any one of (1) to (7), in which the pixel information includes a classification value or a luminance change amount of each pixel generated on the basis of the event data.

9

The image sensor described in any one of (1) to (8) above, in which, in a case in which the event detecting unit is an arbiter type, a frame corresponding to one frame including the event data output at a timing at which an event has occurred from the event detecting unit is generated.

10

The image sensor described in any one of (1) to (9) above, in which the data transmitting unit sets area information corresponding to an area set to an image formed from the event data for each row of the image and transmits the set area information and the event data that becomes the area data corresponding to the area for each row, and information representing a position of a row and information representing a position of a column of the area included in the row are included in the area information.

11

The image sensor described in any one of (1) to (10) above, further including: a luminance detecting unit that detects luminance of light received by the photodiode and outputs a luminance signal representing a luminance value of the luminance; and an additional information generating unit that generates the pixel information as additional information that is additionally disposed in the event data on the basis of the event data, in which the event detecting unit acquires a difference between the luminance value represented by the luminance signal and a predetermined reference value and, in a case in which the difference exceeds an event detection threshold of a positive side or an event detection threshold of a negative side, detects an occurrence of the event and outputs the event data representing details of the event.

12

A data processing device including: a data receiving unit that receives pixel information added to data of each pixel including a photodiode in a frame structure in which the pixel information is embedded in event data with the event data representing details of an event that is a luminance change of light received by the photodiode set as a part of payload data; and an event-related data processing unit that performs data processing relating to the event by referring to the pixel information.

13

The data processing device described in (12) above, in which the data receiving unit receives area information that is set in correspondence with an area set for an image formed from the event data and is set for each row of the image and the event data that becomes area data corresponding to the area, and information representing a position of the row and information representing a position of a column of the area included in the row are included in the area information.

14

The data processing device described in (12) or (13) above, further including a processing unit that is connected to a data bus and performs control of an image formed from the event data output from each of a plurality of image sensors outputting the event data through the data bus, in which the processing unit performs output control of a start packet of a frame in each of the image sensors and output control of an end packet of a frame in each of the image sensors and performs control of connecting a plurality of images from an image including a start packet to an image including an end packet for a plurality of images output from the image sensors.

15

An image sensor system including: an image sensor including: an event detecting unit that detects an occurrence of an event that is a luminance change of light received by a photodiode; and a data transmitting unit that transmits pixel information added to data of each pixel including the photodiode in a frame structure in which the pixel information is embedded in event data with the event data representing details of the event set as a part of payload data, and a data processing device including: a data receiving unit that receives the event data and the pixel information; and an event-related data processing unit that performs data processing relating to the event by referring to the pixel information.

16

The image sensor system described in (15) above, in which data is serially converted and is transmitted between the image sensor and the data processing device, and serial conversion according to one standard and serial conversion according to another standard are configured to be switchable on the image sensor side and the data processing device side.

17

The image sensor system described in (15) or (16) above, in which the data transmitting unit sets area information corresponding to an area set to an image formed from the event data for each row of the image and transmits the set area information and the event data that becomes the area data corresponding to the area for each row, the data receiving unit receives the area information and the event data that becomes the area data, and information representing a position of a row and information representing a position of a column of the area included in the row are included in the area information.

18

The image sensor system described in any one of (15) to (17) above, in which the data processing device includes: a processing unit that is connected to a data bus and performs control of an image formed from the event data output from each of a plurality of image sensors outputting the event data through the data bus, and the processing unit performs output control of a start packet of a frame in each of the image sensors and output control of an end packet of a frame in each of the image sensors and performs control of connecting a plurality of images from an image including a start packet to an image including an end packet for a plurality of images output from the image sensors.

Note that embodiments of the present disclosure are not limited to the above-mentioned embodiments and can be modified in various manners without departing from the scope and spirit of the present disclosure. The advantageous effects described in the present specification are merely exemplary and are not limitative, and other advantageous effects may be achieved.

### Reference Signs List

11 Sensor system
12 EVS
13 Data processing device
14 Data bus
21 Luminance detecting unit
22 Event detecting unit
23 Additional information generating unit
24 Data transmitting unit
25 Pixel chip
26 Signal processing chip
27 AFE chip
28 Logic chip
31 Data receiving unit
32 Event-related data processing unit
41 Event accessing unit
42 Event counting unit
43 Event number analyzing unit
44 Event number frequency analyzing unit
45 Optical flow analyzing unit
46 Data amount calculating unit
47 Frame generating unit
48 SRAM
49 Data amount calculating unit
50 Data compressing unit
51 Degree of attention calculating unit
52 Data processing unit

1. An image sensor comprising:
an event detecting unit that detects an occurrence of an event that is a luminance change of light received by a photodiode; and
a data transmitting unit that sets event data representing details of the event as a part of payload data and transmits pixel information added to data of each pixel including the photodiode in a frame structure in which the pixel information is embedded in the event data.

2. The image sensor according to claim 1, wherein the data transmitting unit inserts information representing an amount of data used in data corresponding to one pixel into a data type in accordance with a data amount of the pixel information embedded in the event data.

3. The image sensor according to claim 1, wherein the pixel information includes a time stamp or a frame number relating to the event data.

4. The image sensor according to claim 1, wherein the pixel information includes an event detection threshold or an event number.

5. The image sensor according to claim 1, wherein the pixel information includes flicker information generated on the basis of the event data.

6. The image sensor according to claim 1, wherein the pixel information includes an optical flow value of each pixel generated on the basis of the event data.

7. The image sensor according to claim 1, wherein the pixel information includes a degree of attention of each pixel.

8. The image sensor according to claim 1, wherein the pixel information includes a classification value or a luminance change amount of each pixel generated on the basis of the event data.

9. The image sensor according to claim 1, wherein, in a case in which the event detecting unit is an arbiter type, a frame corresponding to one frame including the event data output at a timing at which an event has occurred from the event detecting unit is generated.

10. The image sensor according to claim 1,
wherein the data transmitting unit sets area information corresponding to an area set to an image formed from the event data for each row of the image and transmits the set area information and the event data that becomes the area data corresponding to the area for each row, and
wherein information representing a position of a row and information representing a position of a column of the area included in the row are included in the area information.

11. The image sensor according to claim 1, further comprising:
a luminance detecting unit that detects luminance of light received by the photodiode and outputs a luminance signal representing a luminance value of the luminance; and
an additional information generating unit that generates the pixel information as additional information that is additionally disposed in the event data on the basis of the event data,
wherein the event detecting unit acquires a difference between the luminance value represented by the luminance signal and a predetermined reference value and, in a case in which the difference exceeds an event detection threshold of a positive side or an event detection threshold of a negative side, detects an occurrence of the event and outputs the event data representing details of the event.

12. A data processing device comprising:
a data receiving unit that receives pixel information added to data of each pixel including a photodiode in a frame structure in which the pixel information is embedded in event data with the event data representing details of an event that is a luminance change of light received by the photodiode set as a part of payload data; and
an event-related data processing unit that performs data processing relating to the event by referring to the pixel information.

13. The data processing device according to claim 12,
wherein the data receiving unit receives area information that is set in correspondence with an area set for an image formed from the event data and is set for each row of the image and the event data that becomes area data corresponding to the area, and
wherein information representing a position of the row and information representing a position of a column of the area included in the row are included in the area information.

14. The data processing device according to claim 12, further comprising a processing unit that is connected to a data bus and performs control of an image formed from the event data output from each of a plurality of image sensors outputting the event data through the data bus,
wherein the processing unit performs output control of a start packet of a frame in each of the image sensors and output control of an end packet of a frame in each of the image sensors and performs control of connecting a plurality of images from an image including a start packet to an image including an end packet for a plurality of images output from the image sensors.

15. An image sensor system comprising:
an image sensor including:
an event detecting unit that detects an occurrence of an event that is a luminance change of light received by a photodiode; and
a data transmitting unit that transmits pixel information added to data of each pixel including the photodiode in a frame structure in which the pixel information is embedded in event data with the event data representing details of the event set as a part of payload data, and
a data processing device including:
a data receiving unit that receives the event data and the pixel information; and
an event-related data processing unit that performs data processing relating to the event by referring to the pixel information.

16. The image sensor system according to claim 15,
wherein data is serially converted and is transmitted between the image sensor and the data processing device, and
wherein serial conversion according to one standard and serial conversion according to another standard are configured to be switchable on the image sensor side and the data processing device side.

17. The image sensor system according to claim 15,
wherein the data transmitting unit sets area information corresponding to an area set to an image formed from the event data for each row of the image and transmits the set area information and the event data that becomes the area data corresponding to the area for each row,
wherein the data receiving unit receives the area information and the event data that becomes the area data, and
wherein information representing a position of a row and information representing a position of a column of the area included in the row are included in the area information.

18. The image sensor system according to claim 15, wherein the data processing device includes:
a processing unit that is connected to a data bus and performs control of an image formed from the event data output from each of a plurality of image sensors outputting the event data through the data bus, and
wherein the processing unit performs output control of a start packet of a frame in each of the image sensors and output control of an end packet of a frame in each of the image sensors and performs control of connecting a plurality of images from an image including a start packet to an image including an end packet for a plurality of images output from the image sensors.
